(19) United States
(12) Patent Application Publication
(10) Pub. No.: US 2025/0360927 A1
(43) Pub. Date: Nov. 27, 2025

(54) AUTOMATED DRIVING CONTROL DEVICE, STORAGE MEDIUM STORING AUTOMATED DRIVING CONTROL PROGRAM, AND AUTOMATED DRIVING CONTROL METHOD

(71) Applicants: DENSO CORPORATION, Kariya-city (JP); J-QuAD DYNAMICS Inc., Tokyo (JP)

(72) Inventors: Kazuki IZUMI, Kariya-city (JP); Yuuki OZAWA, Tokyo (JP); Ryu KAMBARA, Tokyo (JP); Koji SHIBATA, Tokyo (JP); Yuka SATRE, Tokyo (JP); Yuki YAMAMOTO, Tokyo (JP)

(21) Appl. No.: 19/295,032

(22) Filed: Aug. 8, 2025

Related U.S. Application Data
(63) Continuation of application No. PCT/JP2024/005300, filed on Feb. 15, 2024.

(30) Foreign Application Priority Data
Feb. 17, 2023 (JP) 2023-023000

(51) Int. Cl. B60W 30/18; B60W 30/09; B60W 60/00

(52) U.S. Cl. CPC B60W 30/18163; B60W 30/18159; B60W 60/0011; B60W 30/09; B60W 2520/06; B60W 2552/05; B60W 2552/10; B60W 2554/4029; B60W 2554/4041; B60W 2554/4044; B60W 2554/4046; B60W 2720/10

(57) ABSTRACT

An automated driving control device enables traveling of a subject vehicle by an automated driving function. The automated driving control device is configured to grasp an occurrence of an obstacle that obstructs traveling of the subject vehicle, and sequentially perform peeking control of moving the subject vehicle so as to look in a situation ahead of the obstacle and overtaking control of overtaking the obstacle, in a case where the obstacle occurs in front of the subject vehicle. In a case where the obstacle occurs in an intersection area located in front of the subject vehicle, the automated driving control device changes content of at least one of the peeking control and the overtaking control according to the grasped information in relation to the intersection area.

### CROSS REFERENCE TO RELATED APPLICATIONS

The present application is a continuation application of International Patent Application No. PCT/JP2024/005300 filed on Feb. 15, 2024 which designated the U.S. and claims the benefit of priority from Japanese Patent Application No. 2023-023000 filed on Feb. 17, 2023. The entire disclosures of all of the above applications are incorporated herein by reference.

### TECHNICAL FIELD

The disclosure according to this specification relates to a technique of automated driving control that enables traveling of a subject vehicle by an automated driving function.

### BACKGROUND

In the automated driving device disclosed in a related art, the manual driving switching threshold value having a low value is calculated in a case where the subject vehicle is traveling through an intersection, in a case where an obstacle around the subject vehicle is recognized, or the like. In a case where the operation amount of the driver is equal to or greater than the manual driving switching threshold value, the automated driving device switches the automated driving being executed to the manual driving.

### SUMMARY

According to an aspect of the present disclosure, an automated driving control device enables traveling of a subject vehicle by an automated driving function. The automated driving control device includes at least one of (i) a circuit and (ii) a processor with a memory storing computer program code executable by the processor, the at least one of the circuit and the processor configured to cause the automated driving control device to grasp an occurrence of an obstacle that obstructs traveling of the subject vehicle; and sequentially perform peeking control of moving the subject vehicle so as to look in a situation ahead of the obstacle and overtaking control of overtaking the obstacle, in a case where the obstacle occurs in front of the subject vehicle. In a case where the obstacle occurs in an intersection area located in front of the subject vehicle, the automated driving control device may change content of at least one of the peeking control and the overtaking control according to information in relation to the intersection area.

### BRIEF DESCRIPTION OF DRAWINGS

Objects, features and advantages of the present disclosure will become more apparent from the following detailed description made with reference to the accompanying drawings. In the drawings:

FIG. 1 is a diagram illustrating an overall image of an in-vehicle network including an automated driving ECU according to the first embodiment of the present disclosure;

FIG. 2 is a block diagram illustrating details of an automated driving ECU;

FIG. 3 is a diagram for describing the scene 1 in which peeking control and overtaking control are performed;

FIG. 4 is a diagram for describing the scene 2 in which peeking control and overtaking control are performed;

FIG. 5 is a diagram for describing the scene 3 in which peeking control and overtaking control are performed;

FIG. 6 is a diagram for describing the scene 4 in which peeking control and overtaking control are performed;

FIG. 7 is a diagram for describing the scene 5 in a case where there is a possibility of the following vehicle performing overtaking;

FIG. 8 is a diagram for describing the scene 6 in which a plurality of obstacle vehicles is present;

FIG. 9 is a diagram for describing the scene 7 in which an irregular behavior occurs in the obstacle vehicle;

FIG. 10 is a flowchart illustrating details of the main process of an obstacle avoidance process;

FIG. 11 is a flowchart illustrating details of a peeking control process;

FIG. 12 is a flowchart illustrating details of an overtaking control process together with FIG. 13;

FIG. 13 is a flowchart illustrating details of an overtaking control process together with FIG. 12;

FIG. 14 is a diagram for describing the scene 8 in which peeking control and overtaking control are performed according to the second embodiment of the present disclosure;

FIG. 15 is a diagram for describing the scene 9 in which peeking control and overtaking control are performed;

FIG. 16 is a diagram for describing the scene 10 in which peeking control and overtaking control are performed;

FIG. 17 is a diagram for describing the scene 11 in which peeking control and overtaking control are performed; and

FIG. 18 is a diagram for describing the scene 12 in which peeking control is performed when a vehicle turns right.

### DETAILED DESCRIPTION

In the automated driving device of the related art, in a case where the subject vehicle travels through an intersection, when a preceding vehicle or the like turning right or left is an obstacle, the automated driving is easily suspended by calculating a manual driving switching threshold value having a low value. As described above, when the automated driving is easily suspended at the intersection, it is difficult to ensure the convenience of the automated driving.

The present disclosure provides an automated driving control device, an automated driving control program, and an automated driving control method capable of securing convenience of automated driving.

According to one aspect of the present disclosure, an automated driving control device enables traveling of a subject vehicle by an automated driving function. The automated driving control device comprises: an information grasping section configured to grasp an occurrence of an obstacle that obstructs traveling of the subject vehicle; and a travel control section configured to sequentially perform peeking control of moving the subject vehicle so as to look in a situation ahead of the obstacle and overtaking control of overtaking the obstacle, in a case where the obstacle occurs in front of the subject vehicle. In a case where the obstacle occurs in an intersection area located in front of the subject vehicle, the travel control section changes content of at least one of the peeking control and the overtaking control according to information grasped by the information grasping section in relation to the intersection area.

In these aspects, content of at least one of peeking control for moving the subject vehicle so as to look into the situation ahead of the obstacle and overtaking control for overtaking the obstacle is changed according to information grasped in relation to the intersection area. Therefore, even in the intersection area, the subject vehicle can appropriately avoid an obstacle that hinders traveling of the subject vehicle while continuing the automated driving. Therefore, convenience of automated driving can be ensured.

Hereinafter, a plurality of embodiments of the present disclosure will be described with reference to the drawings. The same reference numerals are given to corresponding components in each embodiment, and redundant description may be omitted. In a case where only part of the configuration is described in each embodiment, the configuration of the other embodiments described above can be applied to other parts of the configuration. In addition, not only a combination of configurations explicitly described in the description of each embodiment but also configurations of a plurality of embodiments can be partially combined even if not explicitly described as long as there is no problem in the combination. It is assumed that combinations of configurations described in a plurality of embodiments and modifications that is not explicitly described are also disclosed by the following description.

### First Embodiment

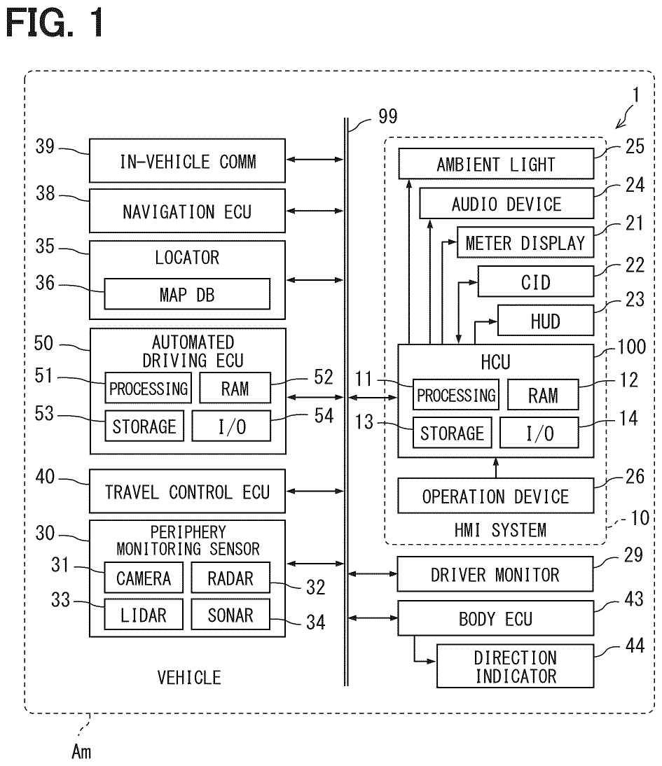

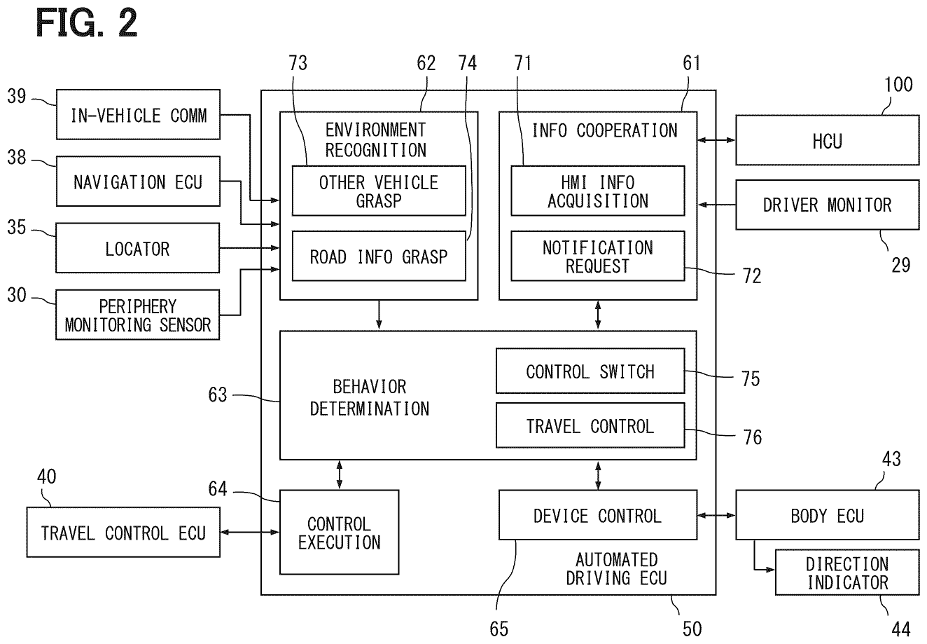

The function of the automated driving control device according to the first embodiment of the present disclosure is realized by an automated driving electronic control section (ECU) 50 illustrated in FIGS. 1 and 2. The automated driving ECU 50 is mounted on a vehicle (hereinafter, subject vehicle Am). By mounting the automated driving ECU 50, the subject vehicle Am is an automated driving vehicle or an autonomous traveling vehicle having an automated driving function, and can travel by the automated driving function.

The automated driving ECU 50 is an in-vehicle ECU that realizes an autonomous traveling function capable of performing a driving operation of a driver on behalf of the driver. The automated driving ECU 50 can perform advanced driving assistance or partial automated driving at about Level 2 and automated driving at Level 3 or higher in which the system is a control subject. The automated driving level in the present disclosure is based on a standard defined by Society of Automotive Engineers.

The automated driving at Level 2 is an automated driving (an eyes-on automated driving) that requires a driver to visually monitor the surroundings of the subject vehicle and has a surroundings monitoring obligation. The automated driving at Level 2 includes hands-on automated driving in which the driver is obliged to grip the steering wheel and hands-off automated driving in which the driver is not obliged to grip the steering wheel.

The automated driving at Level 3 is an eyes-off automated driving in which monitoring around the subject vehicle is unnecessary and there is no surroundings monitoring obligation. The automated driving ECU 50 may be capable of performing fully automated driving at Level 4 in which the system performs all driving tasks under certain conditions, and fully automated driving at Level 5 in which the system performs all driving tasks under all conditions. The automated driving at Level 4 is brain-off automated driving in which a request for a driving-mode switch to the driver does not substantially occur. The automated driving at Level 5 is driverless automated driving that does not require a driver to board.

The automated driving ECU 50 switches the control state of the automated driving function among a plurality of controls including at least automated driving control having a surroundings monitoring obligation at Level 2 or less and automated driving control having no surroundings monitoring obligation at Level 3 or more. In the following description, the automated driving control at Level 2 or lower is referred to as “driving assistance control”, and the automated driving control at Level 3 or higher is referred to as “autonomous travel control”.

In the automated traveling period during which the subject vehicle Am travels by the autonomous travel control, the driver can be permitted to perform a specific action (hereinafter, a second task) other than predetermined driving. The second task is legally permitted to the driver until generation of a driving-mode switch request performed by cooperation of a human machine interface control section (HCU) 100 and the automated driving ECU 50 described later. For example, actions such as viewing entertainment content such as moving image content, operation of a device such as a smartphone, and eating are assumed as the second tasks.

(Configuration of in-Vehicle System)

The automated driving ECU 50 is communicably connected to a communication bus 99 of an in-vehicle network 1 mounted on the subject vehicle Am. A driver monitor 29, a surroundings monitoring sensor 30, a locator 35, a navigation ECU 38, an in-vehicle communication device 39, a travel control ECU 40, a body ECU 43, an HCU 100, and the like are connected to the communication bus 99. These nodes connected to the communication bus 99 can communicate with each other. Specific nodes among these ECUs and the like may be electrically connected directly to each other and may communicate with each other without passing through the communication bus 99. The surroundings monitoring sensor 30 may be referred to as a periphery monitoring sensor.

The driver monitor 29 includes a near-infrared light source, a near-infrared camera, and a control unit that controls these components. The driver monitor 29 is installed, for example, on the upper face of the steering column section or the upper face of the instrument panel in a posture in which the near-infrared camera faces the headrest portion of the driver seat. The driver monitor 29 photographs the head of the driver irradiated with the near-infrared light by the near-infrared light source with the near-infrared camera. The image captured by the near-infrared camera is subjected to image analysis by the control unit. The control unit extracts information such as the position and the line-of-sight direction of the eye point of the driver from the captured image. The driver monitor 29 provides the position information, the line-of-sight direction information, and the like of the eye point extracted by the control unit to the HCU 100, the automated driving ECU 50, and the like as driver status information.

The surroundings monitoring sensor 30 is an autonomous sensor that monitors the environment around the subject vehicle Am. The surroundings monitoring sensor 30 includes, for example, one or more of a camera unit 31, a millimeter wave radar 32, a LiDAR 33, and a sonar 34. The surroundings monitoring sensor 30 can detect a moving object and a stationary object from a detection range around the subject vehicle. The surroundings monitoring sensor 30 provides detection information about an object around the subject vehicle to the automated driving ECU 50 and the like.

The locator 35 includes a global navigation satellite system (GNSS) receiver, an inertial sensor, and the like. The locator 35 combines positioning signals received from a plurality of positioning satellites by the GNSS receiver, measurement results by the inertial sensor, vehicle speed information output to the communication bus 99, and the like to sequentially measure the position, the traveling direction, and the like of the subject vehicle Am. The locator 35 sequentially outputs the position information and the direction information of the subject vehicle Am based on the positioning result to the communication bus 99 as locator information.

The locator 35 further includes a map database (hereinafter, map DB) 36 storing map data. The map DB 36 mainly includes a large-capacity storage medium storing a large number of pieces of three-dimensional map data and two-dimensional map data. The three-dimensional map data is a so-called high definition (HD) map, and includes road information necessary for automated driving. Specifically, the three-dimensional map data includes three-dimensional shape information of the road, detailed information of each lane, and the like. The locator 35 can update the three-dimensional map data and the two-dimensional map data to the latest information by out-of-vehicle communication by the in-vehicle communication device 39. The locator 35 reads map data around the current position from the map DB 36, and provides the map data together with locator information to the automated driving ECU 50, the HCU 100, and the like.

The navigation ECU 38 acquires information about a destination designated by an occupant such as a driver based on the operation information acquired from the HCU 100. The navigation ECU 38 acquires subject vehicle position information and direction information from the locator 35, and sets a route from the current position to the destination. The navigation ECU 38 provides route information indicating a setting route to a destination to the automated driving ECU 50, the HCU 100, and the like. The navigation ECU 38 cooperates with an HMI system 10 to combine a screen display, a voice message, and the like as route guidance to the destination, and notifies the driver of the traveling direction of the subject vehicle Am at the intersection, the branch point, and the like.

Here, a user terminal such as a smartphone may be connected to the in-vehicle network 1 or the HCU 100. Such a user terminal may provide subject vehicle position information, direction information, map data, and the like to the automated driving ECU 50 and the like instead of the locator 35. Further, instead of the navigation ECU 38, the user terminal may provide route information to the destination to the automated driving ECU 50, the HCU 100, and the like.

The in-vehicle communication device 39 is an out-of-vehicle communication unit mounted on the subject vehicle Am, and functions as a vehicle to everything (V2X) communication device. The in-vehicle communication device 39 transmits and receives information to and from a roadside device installed beside the road and another vehicle around the subject vehicle by wireless communication. As an example, the in-vehicle communication device 39 receives congestion information, traffic regulation information, and the like around the current position and in the traveling direction of the subject vehicle Am from a roadside device. The congestion information and the traffic regulation information are, for example, VICS (registered trademark) information and the like.

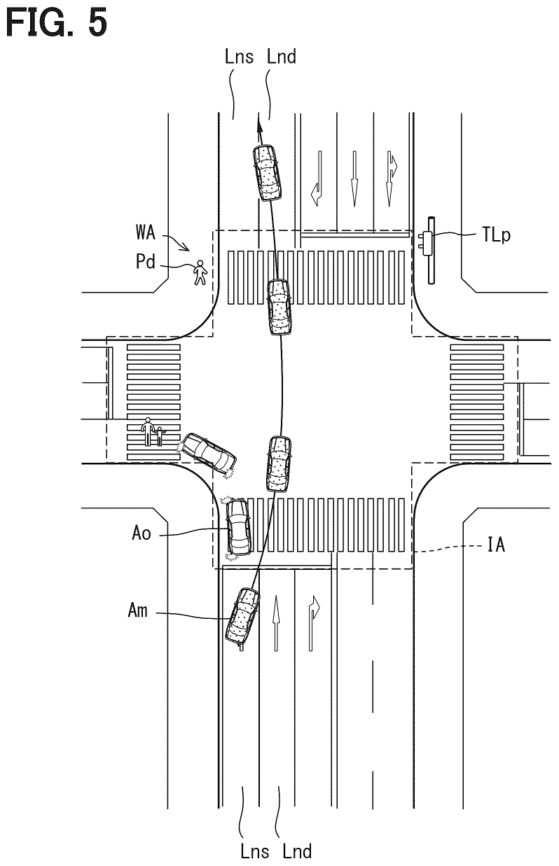

The in-vehicle communication device 39 may be capable of receiving signal information indicating a lighting pattern of a traffic signal installed at the preceding intersection, and detection information about objects around the preceding intersection, for example, a stopped vehicle, a parked vehicle, a pedestrian Pd (see FIG. 5), a cyclist, and the like from a roadside device and another vehicle. The in-vehicle communication device 39 provides the received congestion information, traffic regulation information, signal information, detection information, and the like to the automated driving ECU 50, the HCU 100, and the like.

The travel control ECU 40 is an electronic control device mainly including a microcontroller. The travel control ECU 40 generates vehicle speed information indicating the current traveling speed of the subject vehicle Am based on the detection signal of the wheel speed sensor provided in the hub portion of each wheel, and sequentially outputs the generated vehicle speed information to the communication bus 99. The travel control ECU 40 has at least functions of a brake control ECU, a drive control ECU, and a steering control ECU. The travel control ECU 40 continuously performs braking force control of each wheel, output control of an in-vehicle power source, and steering angle control based on an operation command based on a driving operation of a driver or a control command of the automated driving ECU 50.

The body ECU 43 is an electronic control device mainly including a microcontroller. The body ECU 43 has at least a function of controlling an operation of a lighting device (for example, the direction indicator 44 or the like) mounted on the subject vehicle Am. The body ECU 43 starts blinking of one of left and right direction indicators 44 (blinker) corresponding to an operation direction based on detection of a user operation input to a direction indication switch provided in a steering column section or the like. In addition, based on the control command received from the automated driving ECU 50, the body ECU 43 causes one of the left and right direction indicators 44 corresponding to the moving direction of the subject vehicle Am to start blinking in a case of the automated lane change by the driving assistance control or the autonomous travel control.

The HCU 100 constitutes a human machine interface (HMI) system 10 together with a plurality of display devices, an audio device 24, an ambient light 25, an operation device 26, and the like. The HMI system 10 has an input interface function of receiving an operation by an occupant such as a driver of the subject vehicle Am and an output interface function of presenting information to the driver.

The display device presents information through the vision of the driver by image display or the like. The display devices include a meter display 21, a center information display (CID) 22, a head-up display (hereinafter, HUD) 23, and the like. The CID 22 has a touch panel function, and detects a touch operation on a display screen by a driver or the like.

The audio device 24 includes a plurality of speakers installed in the vehicle interior in an arrangement surrounding the driver seat, and causes the speakers to reproduce a notification sound, a voice message, or the like in the vehicle interior. The ambient light 25 is provided on an instrument panel, a steering wheel, and the like. The ambient light 25 performs information presentation using the surroundings field of view of the driver by ambient display that changes the emission color.

The operation device 26 is an input section that receives a user operation by a driver or the like. For example, a user operation related to the operation and stop of the automated driving function, a user operation related to the setting of the destination of the route guidance, and the like are input to the operation device 26. The operation device 26 includes a steering switch provided on a spoke portion of a steering wheel, an operation lever provided on a steering column section, a voice input device that recognizes utterance content of a driver, and the like.

The HCU 100 is a computer mainly including a control circuit including a processing section 11, a RAM 12, a storage section 13, an input/output interface 14, a bus connecting these, and the like. The HCU 100 functions as a presentation control device, and integrally controls information presentation using a plurality of display devices, the audio device 24, and the ambient light 25.

The HCU 100 presents information related to the automated driving in cooperation with the automated driving ECU 50. The HCU 100 acquires, from the automated driving ECU 50, control status information indicating an operation state of the automated driving function and a request for execution of information presentation related to the automated driving function. The HCU 100 performs content provision and information presentation in accordance with the operation state of the automated driving based on the control status information and the execution request. For example, in a case where the autonomous travel control is scheduled to be terminated by the automated driving ECU 50, the HCU 100 makes a notification of requesting execution of the driving operation, in other words, a notification of requesting a driving-mode switch.

The HCU 100 acquires operation information indicating the content of the user operation from the CID 22, the operation device 26, and the like. The HCU 100 provides the automated driving ECU 50 with operation information about a user operation related to the automated driving function. The HCU 100 provides the navigation ECU 38 with operation information about a user operation for setting a destination of the subject vehicle Am.

### (Configuration of Automated Driving ECU)

The automated driving ECU 50 is a computer mainly including a control circuit including a processing section 51, a RAM 52, a storage section 53, an input/output interface 54, a bus connecting these, and the like. The processing section 51 executes various processes (instructions) for realizing the automated driving control method of the present disclosure by accessing the RAM 52. The storage section 53 stores various programs (automated driving control programs and the like) executed by the processing section 51. By execution of the program by the processing section 51, in the automated driving ECU 50, an information linkage section 61, an environment recognition section 62, an action determination section 63, a control execution section 64, a device control section 65, and the like are constructed as a plurality of function sections for realizing the automated driving function (see FIG. 2). The information linkage section 61 may be referred to as an information cooperation section, and the action determination section 63 may be referred to as a behavior determination section.

The information linkage section 61 provides information to the HCU 100 and acquires information from the HCU 100 and the driver monitor 29. The information linkage section 61 acquires control state information indicating an operation state of the automated driving function from the action determination section 63, and provides the acquired control state information to the HCU 100. The control state information includes information indicating the automated driving level of the automated driving function in the operation state. The information linkage section 61 includes an HMI information acquisition section 71 and a notification request section 72 as sub-function sections for information linkage with the HCU 100 and the driver monitor 29.

The HMI information acquisition section 71 grasps the content of the user operation input to the CID 22, the operation device 26, and the like by the driver and the like based on the operation information acquired from the HCU 100. The HMI information acquisition section 71 grasps, for example, a Level 2 transition operation for instructing a transition from manual driving to driving assistance control, a Level 3 transition operation for instructing a transition from driving assistance control to autonomous travel control, and the like. Further, the HMI information acquisition section 71 grasps the action of the driver based on the driver status information acquired from driver monitor 29. The HMI information acquisition section 71 continuously grasps the driving posture, the line-of-sight direction, whether the surroundings monitoring is performed, whether the second task is performed, the degree of awakening, and the like of the driver during the traveling period by the driving assistance control or the autonomous travel control.

The notification request section 72 enables notification by the HCU 100 synchronized with the operation state of the automated driving function by outputting the notification execution request to the HCU 100. For example, in a case where the termination of the autonomous travel control is scheduled, the notification request section 72 outputs an execution request for a notification of requesting a driving-mode switch to the HCU 100. The notification request section 72 outputs a notification execution request related to peeking control and overtaking control described later to the HCU 100. The peeking control may be referred to as a look-in control. Based on the notification request acquired from the notification request section 72, the HCU 100 makes a notification in which virtual image display or screen display by the display device, reproduction of a notification sound or message by the audio device 24, ambient display by the ambient light 25, and the like are appropriately combined.

The environment recognition section 62 combines the locator information and the map data acquired from the locator 35 with the detection information acquired from the surroundings monitoring sensor 30 to recognize the travel environment of the subject vehicle Am. The environment recognition section 62 can use the detection information received by the in-vehicle communication device 39 for recognition of the travel environment. The environment recognition section 62 acquires route information from the navigation ECU 38 and provides the acquired route information to the action determination section 63. The environment recognition section 62 acquires, from communication bus 99, vehicle speed information indicating a current traveling speed as information indicating a state of subject vehicle Am. The environment recognition section 62 includes an another vehicle grasping section 73 and a road grasping section 74 as sub-function sections for travel environment recognition. The road grasping section 74 may be referred to as a road information grasping section.

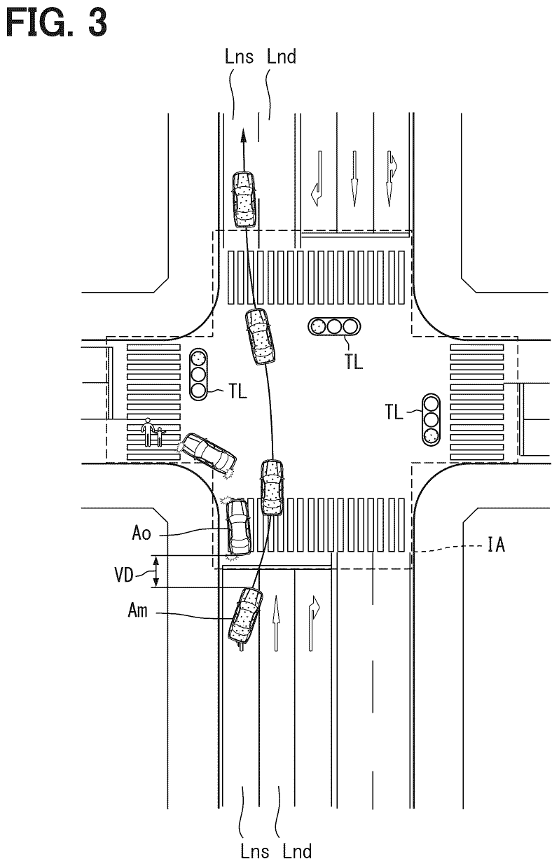

The another vehicle grasping section 73 grasps a relative position, a relative speed, and the like of a dynamic target around the subject vehicle, such as another vehicle traveling around the subject vehicle Am. The another vehicle grasping section 73 grasps the occurrence of an obstacle that obstructs traveling of the subject vehicle Am (see an obstacle vehicle Ao in FIG. 3), for example, in a scene where the peeking control and the overtaking control described later are performed. The another vehicle grasping section 73 grasps relative positions and the like of a temporarily stopped vehicle, an on-road parked vehicle, a construction vehicle, and the like located in front of the subject vehicle Am. Further, the another vehicle grasping section 73 grasps the relative position, the relative speed, and the like of another vehicle traveling in an adjacent lane Lnd (see FIG. 3), and determines whether there is a space where the subject vehicle Am can move in the adjacent lane Lnd.

The road grasping section 74 acquires information related to a road on which the subject vehicle Am travels or a road on which the subject vehicle Am is scheduled to travel. Specifically, in a case where the subject vehicle Am is traveling on a road including a plurality of lanes, the road grasping section 74 identifies the position of the subject vehicle lane Lns (see FIG. 3) on which the subject vehicle Am travels. In addition, the road grasping section 74 acquires route information acquired from the navigation ECU 38 and identifies a lane on which the subject vehicle Am should travel among the plurality of lanes.

The road grasping section 74 grasps whether the road on which the subject vehicle Am travels or the road on which the subject vehicle Am is scheduled to travel is within a preset permitted area. In the permitted area, the execution of the autonomous travel control at Level 3 or higher is permitted. The condition as to whether the area is a permitted area corresponds to a road condition in an operational design domain. The operational design domain is a unique condition related to a design travel environment that is a premise on which the automated driving ECU 50 normally operates, and is set according to the ability of the automated driving ECU 50. The information indicating whether the area is a permitted area may be recorded in map data stored in the map DB 36 or may be included in reception information received by the in-vehicle communication device 39. For example, an expressway, an automobile exclusive road, a specific general road maintained so as to enable automated driving, and the like are set as permitted areas.

In a case where the automated driving ECU 50 has the control right of the driving operation, the action determination section 63 generates a scheduled travel line on which the subject vehicle Am travels based on the recognition result of the travel environment by the environment recognition section 62 and the route information generated by the navigation ECU 38. The action determination section 63 outputs the generated scheduled travel line to the control execution section 64. The action determination section 63 includes the control switching section 75 as a sub-function section that controls the operation state of the automated driving function.

The control switching section 75 cooperates with the HCU 100 to control the driving-mode switch between the automated driving ECU 50 and the driver. The control switching section 75 switches between driving assistance control at Level 2 in which the driver is obliged to monitor the surroundings and autonomous travel control at Level 3 or higher in which the driver is not obliged to monitor the surroundings. The control switching section 75 permits the execution of automated driving at Level 3 or higher on roads within the permitted area, and permits only the execution automated driving at Level 2 on roads outside the permitted area. Further, the control switching section 75 performs switching between the automated driving at Level 3 and the automated driving at Level 4 or Level 5 in the autonomous travel control without the surroundings monitoring obligation. The control switching section 75 generates control state information indicating a current operation state of the automated driving function, and provides the generated control state information to the information linkage section 61 or the like.

In a case where the automated driving ECU 50 has the control right of the driving operation, the control execution section 64 executes acceleration/deceleration control, steering control, and the like of the subject vehicle Am in accordance with the scheduled travel line generated by the action determination section 63 in cooperation with the travel control ECU 40. Specifically, the control execution section 64 generates a control command based on the scheduled travel line, and sequentially outputs the generated control command to the travel control ECU 40.

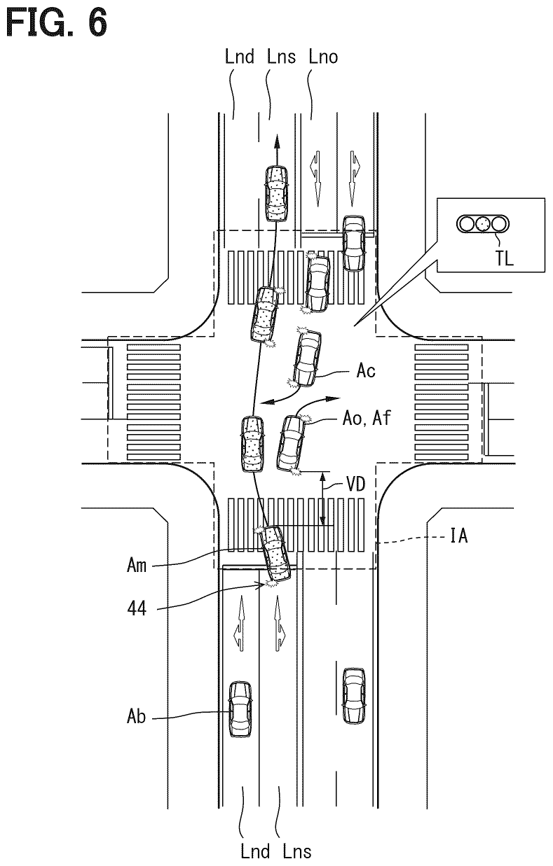

The device control section 65 controls the start and termination of the blinking operation of the direction indicator 44 by outputting a control command to the body ECU 43. The device control section 65 causes the direction indicators 44 close to the adjacent lane Lnd and close to the subject vehicle lane Lns to perform the blinking operation continuously in accordance with the execution of the peeking control and the overtaking control to be described later (see FIG. 6).

### (Peeking Control and Overtaking Control)

In the automated driving ECU 50 described above, a travel control section 76 is provided in the action determination section 63 as a sub-function section. When the environment recognition section 62 grasps the occurrence of an obstacle ahead of the subject vehicle that obstructs traveling of the subject vehicle Am, the travel control section 76 performs overtaking control of overtaking the obstacle. At this time, the travel control section 76 performs peeking control before starting the overtaking control. The peeking control is low-speed movement control in which the front portion of the subject vehicle Am is brought close to the adjacent lane so as to check the place ahead of the obstacle from behind the obstacle. According to the peeking control, the front portion of the subject vehicle Am is in the state in which the subject vehicle is out of its lane into the adjacent lane according to the situation. By performing the peeking control, the driver or the surroundings monitoring sensor 30 during the surroundings monitoring can easily check the situation ahead of the obstacle.

The above-described peeking control and overtaking control are performed, for example, in a scene of overtaking a parked vehicle as an obstacle parked on a road in two opposite lanes. Furthermore, the peeking control and the overtaking control are performed not only in a scene in which the vehicle travels on such a general road but also in a scene of passing through an intersection or the like. The peeking control and the overtaking control are performed both under a control state at Level 2 (hands-off) in which the driver is obliged to monitor the surroundings and under a control state at Level 3 or higher in which the driver is not obliged to monitor the surroundings.

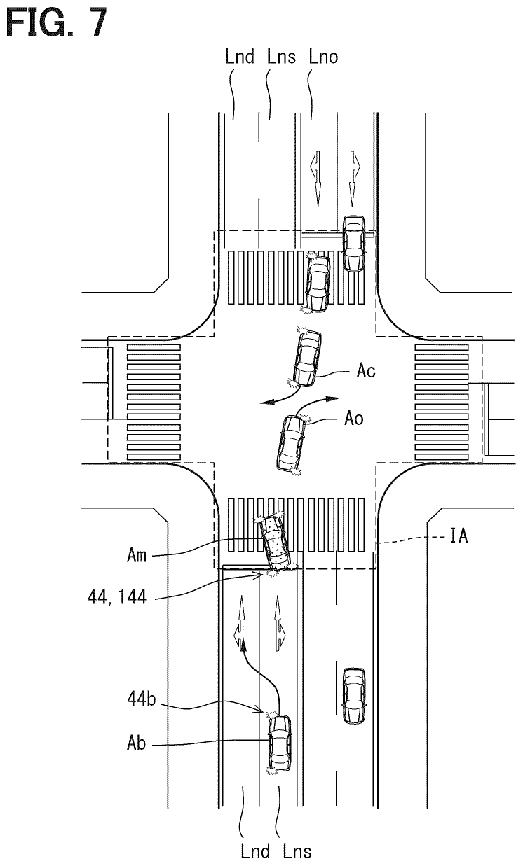

Specifically, in an intersection area IA (see FIG. 3), the environment recognition section 62 recognizes, as obstacle vehicles Ao (see FIG. 3), a preceding vehicle located in front of the subject vehicle Am, such as a stopped vehicle waiting for a right or left turn, a parked vehicle parked on the road, and a construction vehicle involved in road construction. As an example, the intersection area IA is defined between the respective stop lines surrounding the intersection so as to include a range in which a crosswalk is provided. The environment recognition section 62 grasps, as information related to the intersection area IA, whether the subject vehicle Am is located in the intersection area IA, whether a traffic signal TL (see FIG. 3) is installed at the intersection, whether a following vehicle Ab (see FIGS. 6 and 7) is present, and the like. In addition, the environment recognition section 62 grasps whether the section where execution of the overtaking control is scheduled overlaps the intersection area IA, whether there is a space for the subject vehicle Am ahead of the intersection area IA, whether there is an oncoming vehicle Ac (see FIGS. 6 and 7), and the like. In addition, the environment recognition section 62 grasps whether the remaining distance from the subject vehicle Am to the intersection area IA (a stop line or the like in front of the subject vehicle Am) exceeds a predetermined distance.

In a case where the obstacle vehicle Ao occurs in the intersection area IA located in front of the subject vehicle Am, the travel control section 76 changes content of at least one of the peeking control and the overtaking control according to the above information grasped by the environment recognition section 62 in relation to the intersection area IA. Specifically, the travel control section 76 changes content of the peeking control according to whether the subject vehicle Am is located in the intersection area IA, whether the traffic signal TL is installed in the intersection area IA, whether the following vehicle Ab is present, and the like. In addition, the travel control section 76 changes content of the overtaking control according to whether the section where execution of the overtaking control is scheduled overlaps the intersection area IA, whether there is a space for the subject vehicle Am ahead of the intersection area IA, whether there is the oncoming vehicle Ac, and the like. In addition, the travel control section 76 changes content of the overtaking control according to whether the remaining distance from the subject vehicle Am to the intersection area IA exceeds a predetermined distance.

Hereinafter, details of a plurality of scenes in which the peeking control and the overtaking control are performed in the intersection area IA will be described with reference to FIGS. 1 and 2 based on FIGS. 3 to 9.

The following description is based on a traffic environment in which the vehicle travels on the left side. The peeking control and the overtaking control of the present disclosure are also applicable to a traffic environment in which the vehicle travels on the right side. Specifically, the content of each control described later for overtaking the obstacle vehicle Ao from right is applicable to each control for overtaking the obstacle vehicle Ao from left in a traffic environment where the vehicle travels on the right side. Similarly, the content of each control described later for overtaking the obstacle vehicle Ao from left is applicable to each control for overtaking the obstacle vehicle Ao from right in a traffic environment where the vehicle travels on the right side. In addition, in a traffic environment in which the vehicle travels on the left side, a right turn is intersection passing that crossing the opposite lane Lno, and a left turn is intersection passing that not crossing the opposite lane Lno. On the other hand, in a traffic environment where the vehicle travels on the right side, a left turn is intersection passing that crossing the opposite lane Lno, and a right turn is intersection passing that not crossing the opposite lane Lno. Therefore, the matters related to the right or left turn to be described later can be applied to a traffic environment in which the vehicle travels on the right side by switching the right and the left.

### (Scene 1: Scene of Overtaking Left Turn Waiting Vehicle)

In the scene 1 illustrated in FIG. 3, the peeking control and the overtaking control for avoiding the obstacle vehicle Ao waiting for a left turn in the intersection area IA are performed. In the scene 1, the subject vehicle Am performs peeking control outside the intersection area IA. In such a scene, the environment recognition section 62 determines whether the position of the subject vehicle Am is in the intersection area IA, in other words, whether the subject vehicle Am has entered the intersection area IA.

The travel control section 76 changes content of the peeking control depending on whether the peeking control is performed inside the intersection area IA (see FIG. 6) or the peeking control is performed outside the intersection area IA. Specifically, the travel control section 76 changes the inter-vehicle distance VD to the obstacle vehicle Ao subjected to the peeking control inside and outside the intersection area IA. The travel control section 76 shortens an inter-vehicle distance VD between the subject vehicle Am and the obstacle vehicle Ao in a case where the peeking control is performed outside the intersection area IA, compared with in the case where the peeking control is performed inside the intersection area IA.

The travel control section 76 changes the threshold value of the time until each execution of peeking control between the peeking control in the intersection area IA and the peeking control outside the intersection area IA. In a case where the peeking control is performed outside the intersection area IA, the travel control section 76 causes the subject vehicle Am to temporary stop before the obstacle vehicle Ao. After the temporary stop, the subject vehicle Am starts to move to look into the adjacent lane Lnd. On the other hand, in a case where the peeking control is performed in the intersection area IA, the travel control section 76 omits the temporary stop before the obstacle vehicle Ao.

In the peeking control, the travel control section 76 moves the subject vehicle Am to a position where the driver or the surroundings monitoring sensor 30 can grasp the situation ahead of the obstacle vehicle Ao while performing steering control on the overtaking side (right side in FIG. 3). The travel control section 76 may cooperate with the environment recognition section 62 to move the subject vehicle Am forward to a position where the detection range of the surroundings monitoring sensor 30 satisfies a predetermined condition. The travel control section 76 temporarily stops the subject vehicle Am in a state where the front portion of the subject vehicle Am is out of its lane to the overtaking side relative to the side face of the obstacle vehicle Ao. The front portion of the subject vehicle Am may be out of its lane into the adjacent lane Lnd.

With the execution of the peeking control, the environment recognition section 62 checks whether there is a space for the subject vehicle Am in the lane (subject vehicle lane Lns) where the subject vehicle Am returns after the overtaking control. In a case where it is confirmed that there is a space for the subject vehicle Am ahead of the intersection area IA, the travel control section 76 shifts the peeking control to the overtaking control. At this time, the notification request section 72 causes the HMI system 10 to make a notification (hereinafter, control transition notification) indicating the transition from the peeking control to the overtaking control to the occupant such as the driver. As an example, a change in the status display of the meter display 21 notifies the driver or the like of the transition from the peeking control to the overtaking control.

The travel control section 76 changes content of the overtaking control between in a case where the overtaking control is performed in a section including the intersection area IA and in a case where the overtaking control is performed in a section not including the intersection area IA. Specifically, the travel control section 76 suppresses the traveling speed of the subject vehicle Am in the overtaking control and performs overtaking at a low speed in a case where the overtaking control is performed in the section including the intersection area IA, compared with in a case where the overtaking control is performed in the section not including the intersection area IA. As an example, the travel control section 76 sets the upper limit of the traveling speed of the subject vehicle Am in the overtaking control to a speed higher (higher) by a predetermined speed (for example, about 20 km/h) than the traveling speed (for example, the low-down speed) in the peeking control.

The travel control section 76 causes the subject vehicle Am to travel at a low speed so as to pass right of the obstacle vehicle Ao. After overtaking the obstacle vehicle Ao or the like, the subject vehicle Am starts moving to the left side in the intersection area IA and returns to the subject vehicle lane Lns. The travel control section 76 increases the degree of curved movement of the subject vehicle Am to the direction (right side in FIG. 3) away from the obstacle vehicle Ao to be overtaken in a case where the overtaking control is performed in the section including the intersection area IA, compared with in a case where the overtaking control is performed in the section not including the intersection area IA.

In a case where the environment recognition section 62 detects at least one of the oncoming vehicle Ac and the following vehicle Ab, the device control section 65 operates the direction indicator 44 in accordance with the overtaking control (see FIG. 6). On the other hand, in a case where the environment recognition section 62 does not detect the oncoming vehicle Ac and the following vehicle Ab, the operation of the direction indicator 44 in the overtaking control is omitted.

Here, the traffic signal TL is installed in the intersection area IA illustrated in FIG. 3. The environment recognition section 62 grasps whether the traffic signal TL is installed in the intersection area IA. In a case where the traffic signal TL is installed in the intersection area IA, the environment recognition section 62 further grasps the state of the traffic signal TL in front of (front face of) the subject vehicle, that is, the lighting pattern (lighting state) of the traffic signal TL. The environment recognition section 62 grasps which of blue, yellow, and red is lit for the traffic signal TL. In a case where the lighting pattern of the traffic signal TL in front of the subject vehicle cannot be grasped, the environment recognition section 62 may grasp the lighting pattern of the traffic signal TL in the left-right direction and determine whether the traffic signal TL is in a red light state.

In a case where the traffic signal TL is installed in the intersection area IA and the traffic signal TL in front of the subject vehicle is in a green light state, or in a case where both the traffic signals TL in the left-right direction are in a red light state, the travel control section 76 performs the peeking control and the overtaking control. On the other hand, in a case where the traffic signal TL in front of the subject vehicle is in lighting state in yellow or red, the travel control section 76 restricts execution of the peeking control. When the traffic signal TL changes from the blue lighting state to the yellow lighting state, the travel control section 76 immediately stops the peeking control. In a case where the traffic signal TL is in the yellow lighting state, the travel control section 76 does not start the peeking control as in the case where the traffic signal TL is in the red lighting state.

In a case where the traffic signal TL is not installed in the intersection area IA, the travel control section 76 restricts execution of the peeking control and the overtaking control. Specifically, the travel control section 76 does not perform peeking control and overtaking control in the intersection area IA where there is no traffic signal TL. Alternatively, in the intersection area IA without the traffic signal TL, the travel control section 76 may perform overtaking control while maintaining the low-down speed in the peeking control, or may perform peeking control and overtaking control so as to travel at a position that does not become a blind spot from another surrounding vehicle.

### (Scene 2: Scene of Congestion Ahead of Intersection Area)

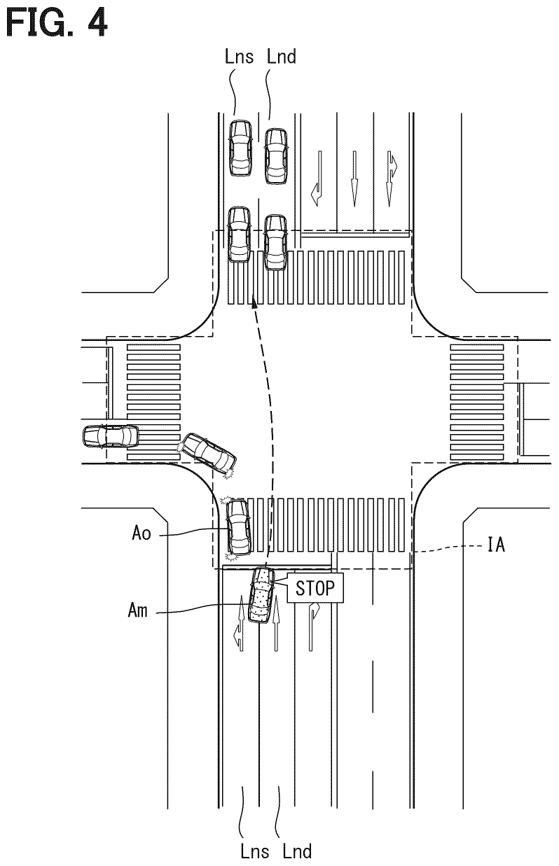

In the scene 2 illustrated in FIG. 4, as in the scene illustrated in FIG. 3, the peeking control and the overtaking control for avoiding the obstacle vehicle Ao waiting for a left turn in the intersection area IA are performed. In the scene illustrated in FIG. 4, the road ahead of the intersection area IA is congested. Therefore, by performing the peeking control, the environment recognition section 62 determines that there is no space for the subject vehicle Am in the subject vehicle lane Lns ahead of the intersection area IA before the subject vehicle Am enters the intersection area IA.

In a case where there are a large number of preceding vehicles ahead of the intersection area IA and the subject vehicle Am cannot exit the intersection area IA, the travel control section 76 changes content of the overtaking control so that a predetermined space is secured ahead of the intersection area IA. As an example, the travel control section 76 restricts the entry of the subject vehicle Am into the intersection area IA by the overtaking control. The subject vehicle Am waits for a space to be created ahead of the intersection area IA in a state of straddling the subject vehicle lane Lns and the adjacent lane Lnd before the intersection area IA. The travel control section 76 starts the subject vehicle Am at a timing when a predetermined space is created ahead of the intersection area IA.

As another example, the travel control section 76 suppresses the traveling speed of the subject vehicle Am in the overtaking control in a case where there is not the predetermined space ahead of the intersection area IA, compared with in a case where there is a space. The travel control section 76 adjusts the speed of the subject vehicle Am traveling in the intersection area IA so as to reach a place ahead of the intersection area IA at a timing when a predetermined space is secured by the movement of the preceding vehicle.

(Scene 3: Overtaking Scene where there is Pedestrian Waiting for Crossing)

In the scene 3 illustrated in FIG. 5, as in the scene illustrated in FIG. 3 and the like, the peeking control and the overtaking control for avoiding the obstacle vehicle Ao waiting for a left turn in the intersection area IA are performed. In the scene illustrated in FIG. 5, a pedestrian Pd is present in a waiting area WA facing an intersection area IA. In order to cross the crosswalk, the pedestrian Pd waits for a traffic signal TLp for the pedestrian to change in the vicinity of the roadway (subject vehicle lane Lns).

The environment recognition section 62 grasps whether the pedestrian Pd is present in the one waiting area WA (left side in FIG. 5) where the subject vehicle moves in the second half of the overtaking control in the left-right direction. In a case where the pedestrian Pd is present in the waiting area WA, the travel control section 76 changes the travel line of the subject vehicle Am in the overtaking control. Specifically, the travel control section 76 increases the degree of curved movement of the subject vehicle Am in a direction away from the pedestrian Pd (right side in FIG. 5) in a case where the pedestrian Pd is present in the waiting area WA, compared with in a case where the pedestrian Pd is not present in the waiting area WA. In other words, the travel control section 76 extends the section where execution of the overtaking control is scheduled forward and adjusts the travel line to delay the timing of returning from the adjacent lane Lnd to the subject vehicle lane Lns. As a result, a distance between the pedestrian Pd and the subject vehicle Am is secured, and it is possible to make it difficult to give the pedestrian Pd an impression that the subject vehicle Am is approaching.

### (Scene 4: Scene of Overtaking Right Turn Waiting Vehicle)

In the scene 4 illustrated in FIG. 6, the peeking control and the overtaking control for avoiding the obstacle vehicle Ao waiting for the right turn in the intersection area IA are performed. In the scene illustrated in FIG. 6, the subject vehicle Am performs peeking control and overtaking control after entering the intersection area IA. The environment recognition section 62 determines that the position of the subject vehicle Am is in the intersection area IA.

, the travel control section 76 sets the inter-vehicle distance VD to the obstacle vehicle Ao to be subjected to the peeking control in a case where the peeking control is performed in the intersection area IA to be longer than that in a case where the peeking control is performed outside the intersection area IA (see FIG. 3). In addition, in a case where the peeking control is performed in the intersection area IA, the travel control section 76 omits the temporary stop performed before the obstacle vehicle Ao. The travel control section 76 decelerates the subject vehicle Am to a slow down state, then performs steering control on the overtaking side (left side in FIG. 6), and performs movement for looking into the adjacent lane Lnd.

Before the start of the peeking control, the environment recognition section 62 grasps a preceding vehicle Af located in front of the subject vehicle Am in the intersection area IA. The preceding vehicle Af may be the obstacle vehicle Ao waiting for a right turn in the intersection area IA. The environment recognition section 62 grasps whether the preceding vehicle Af is stopped together with the presence of the preceding vehicle Af. In the peeking control, the environment recognition section 62 grasps the presence of the following vehicle Ab traveling behind the subject vehicle Am and the oncoming vehicle Ac waiting for a right turn in the opposite lane Lno. In a case of grasping the presence of the following vehicle Ab, the environment recognition section 62 further grasps the relative position and the relative speed of the following vehicle Ab with respect to the subject vehicle Am.

In a case where the preceding vehicle Af is moving, the travel control section 76 restricts execution of the peeking control in which the preceding vehicle Af is set as the obstacle vehicle Ao. That is, in a case where the preceding vehicle Af is not stopped, the travel control section 76 does not perform peeking control for grasping the situation ahead of the preceding vehicle Af. In a case where the environment recognition section 62 grasps the following vehicle Ab, the travel control section 76 changes content of the peeking control. In a case where the following vehicle Ab is present, the travel control section 76 changes the position to look into in the peeking control according to the relative position of the following vehicle Ab. Specifically, the travel control section 76 suppresses the look-in amount of the subject vehicle Am in the peeking control in a case where the following vehicle Ab is present in the adjacent lane Lnd on the moving side (left side in FIG. 6) of the subject vehicle Am, compared with in a case where the following vehicle Ab is present in the subject vehicle lane Lns. The look-in amount is an amount where the front portion of the subject vehicle Am is out of its lane from the reference position to the adjacent lane Lnd with the section line between the subject vehicle lane Lns and the adjacent lane Lnd as the reference position. In a case where the following vehicle Ab is present in the adjacent lane Lnd, the travel control section 76 sets the look-in amount to substantially 0, and temporarily stops the subject vehicle Am at a position where the front portion is not out of its lane into a region obtained by extending the adjacent lane Lnd in the intersection area IA. The reference position for defining the look-in amount may not be a section line between the subject vehicle lane Lns and the adjacent lane Lnd, but may be a side face, of the obstacle vehicle Ao, close to the adjacent lane Lnd.

In a case where the following vehicle Ab is present, the travel control section 76 increases or decreases the look-in amount according to the relative speed of the following vehicle Ab. The travel control section 76 decreases the look-in amount as the relative speed of the following vehicle Ab increases, and increases the look-in amount as the relative speed of the following vehicle Ab decreases. Further, the travel control section 76 secures a long inter-vehicle distance VD from the subject vehicle Am to the obstacle vehicle Aoin in a case where the following vehicle Ab is present in the adjacent lane Lnd, compared with in a case where the following vehicle Ab is present in the subject vehicle lane Lns.

In a case where at least one of the oncoming vehicle Ac and the following vehicle Ab is recognized by the environment recognition section 62, the device control section 65 operates the direction indicator 44. After the following vehicle Ab has overtaken the subject vehicle Am, the device control section 65 starts blinking of the moving side direction indicator 44 (left side in FIG. 6) before traveling in the overtaking control is started. The device control section 65 terminates blinking of the direction indicator 44 before the subject vehicle Am overtakes the obstacle vehicle Ao. Further, the device control section 65 starts blinking of the return side direction indicator 44 (right side in FIG. 6) at the timing when the oncoming vehicle Ac and the subject vehicle Am pass each other. The device control section 65 terminates blinking of the direction indicator 44 at timing when the subject vehicle Am returns to the subject vehicle lane Lns.

(Scene 5: Scene in which Overtaking by Following Vehicle is Prioritized)

In the scene 5 illustrated in FIG. 7, as in the scene illustrated in FIG. 6, the obstacle vehicle Ao waiting for a right turn in the intersection area IA is for the peeking control. In the scene illustrated in FIG. 7, the following vehicle Ab is present in the subject vehicle lane Lns. The following vehicle Ab makes a lane change to the adjacent lane Lnd (left side in FIG. 7) in order to overtake the subject vehicle Am and the obstacle vehicle Ao.

In a case of grasping the following vehicle Ab in the subject vehicle lane Lns, the environment recognition section 62 determines whether there is a possibility (possibility of overtaking) that the following vehicle Ab will overtake the subject vehicle Am and the obstacle vehicle Ao. In a case of recognizing the operation of the direction indicator 44b of the following vehicle Ab, the environment recognition section 62 determines that there is a possibility of the following vehicle Ab performing overtaking. In addition, in a case of recognizing the lateral movement of the following vehicle Ab toward the adjacent lane Lnd, the environment recognition section 62 determines that there is a possibility of the following vehicle Ab performing overtaking. Further, in a case where the relative speed of the following vehicle Ab is equal to or higher than a predetermined speed, the environment recognition section 62 determines that there is a possibility of the following vehicle Ab performing overtaking.

In a case where the environment recognition section 62 determines that there is a possibility of the following vehicle Ab performing overtaking, the travel control section 76 restricts execution of the peeking control. In a case where the possibility of the following vehicle Ab performing overtaking is determined before the start of the peeking control, the travel control section 76 suspends the start of the peeking control. On the other hand, in a case where the possibility of the following vehicle Ab performing overtaking is determined after the start of the peeking control, the travel control section 76 suspends the peeking control and puts the subject vehicle Am into a standby state. At this time, the device control section 65 terminates blinking of the direction indicator 44 close to the adjacent lane Lnd and starts blinking of the hazard lamps 144.

(Scene 6: Scene in which a Plurality of Obstacle Vehicles is Present)

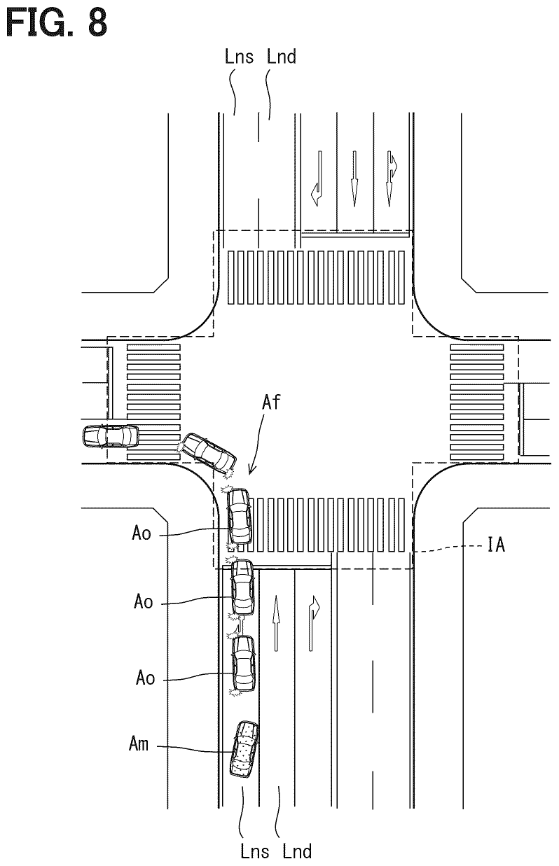

In the scene 6 illustrated in FIG. 8, as in the scene illustrated in FIG. 3 and the like, the obstacle vehicle Ao waiting for a left turn in the intersection area IA is for the peeking control. In the scene illustrated in FIG. 8, a plurality of preceding vehicles Af is waiting for a left turn as the obstacle vehicles Ao. The environment recognition section 62 grasps that there is a plurality of obstacle vehicles Ao by the peeking control. In this case, the environment recognition section 62 further grasps the remaining distance from the subject vehicle Am to the intersection area IA.

The travel control section 76 changes a permission criterion for permitting the transition from the peeking control to the overtaking control according to the remaining distance. Specifically, in a case where the remaining distance to the intersection area IA exceeds the predetermined distance, in other words, in a case where the subject vehicle Am is away from the intersection area IA, the travel control section 76 permits the transition from the peeking control to the overtaking control even if there is a plurality of obstacle vehicles Ao. On the other hand, in a case where the distance to the intersection area IA does not exceed the predetermined distance (within the predetermined distance), in other words, in a case where the subject vehicle Am is located in the vicinity of the intersection area IA (see FIG. 8), the travel control section 76 does not permit the transition from the peeking control to the overtaking control. In this case, the subject vehicle Am may stop the overtaking control, or may wait for the start of the overtaking control in the subject vehicle lane Lns until the number of the obstacle vehicle Ao decreases to one.

(Scene 7: Scene where Irregular Behavior Occurs in Obstacle Vehicle)

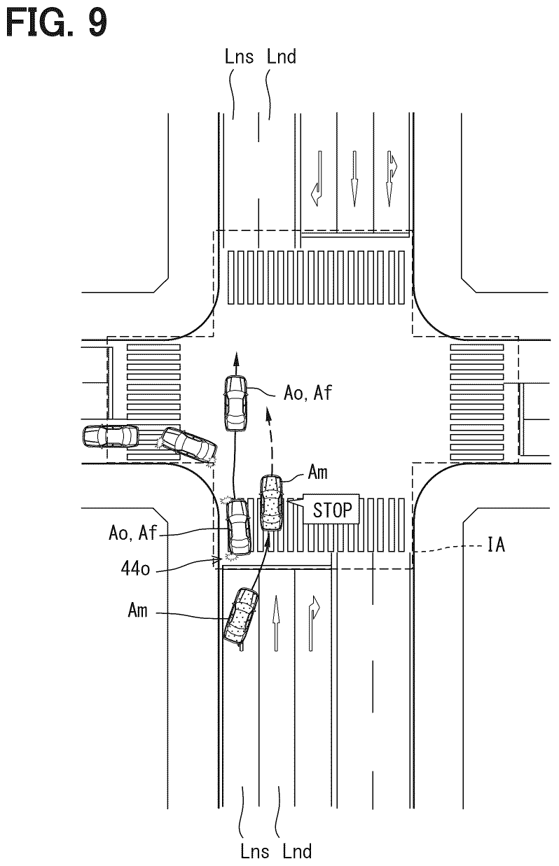

In the scene 7 illustrated in FIG. 9, as in the scene illustrated in FIG. 3 and the like, the obstacle vehicle Ao (preceding vehicle Af) waiting for a right turn in the intersection area IA is for the peeking control. In the scene illustrated in FIG. 9, the course of the obstacle vehicle Ao is suddenly changed from the left turn to straight traveling. The environment recognition section 62 grasps such irregular behavior of the obstacle vehicle Ao. The environment recognition section 62 determines that an irregular behavior has occurred in the obstacle vehicle Ao in a case where the blinking of the direction indicator 440 of the obstacle vehicle Ao is stopped or in a case where the obstacle vehicle Ao starts moving in the straight traveling direction.

In a case where the environment recognition section 62 grasps the irregular behavior after the start of the overtaking control, the travel control section 76 suspends the overtaking control and temporarily stops the subject vehicle Am. After the obstacle vehicle Ao leaves the intersection area IA, the travel control section 76 resumes traveling of the subject vehicle Am and changes the lane to the subject vehicle lane Lns. On the other hand, in a case where the environment recognition section 62 grasps the irregular behavior before the overtaking control is started, the travel control section 76 causes the subject vehicle Am to follow the obstacle vehicle Ao and leave the intersection area IA.

### (Details of Obstacle Avoidance Process)

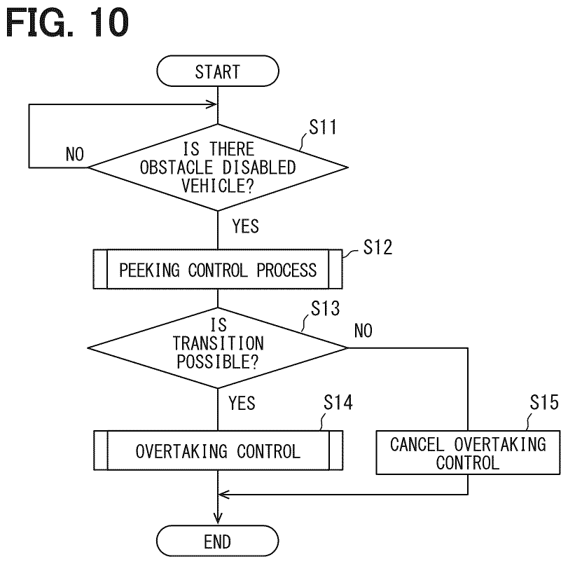

Next, details of the obstacle avoidance process performed by the automated driving ECU 50 in order to implement the above-described peeking control and overtaking control will be described below with reference to FIGS. 1 to 9 based on FIGS. 10 to 13.

The main process of the obstacle avoidance process illustrated in FIG. 10 is started by the automated driving ECU 50 on condition that the subject vehicle approaches the intersection area IA by a predetermined distance (for example, about 1 km). The peeking control and the overtaking control are sequentially performed based on the main process. The main process is continuously performed until the subject vehicle passes through the intersection area IA, and is terminated after the subject vehicle passes through the intersection area IA.

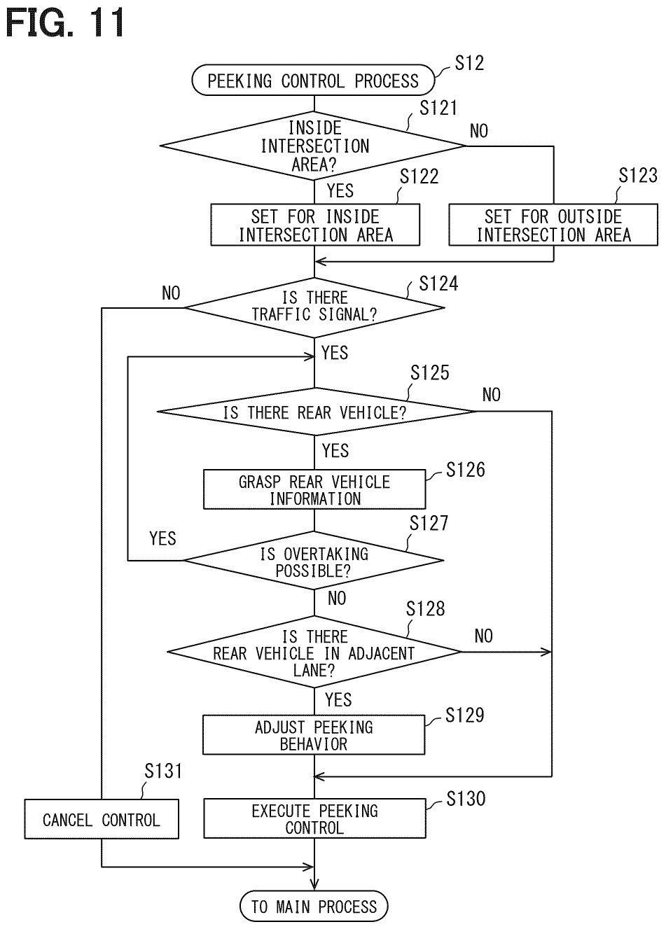

In S11 of the main process, the environment recognition section 62 grasps the occurrence of the obstacle vehicle Ao that obstructs traveling of the subject vehicle Am. The environment recognition section 62 determines whether the obstacle vehicle Ao is present in the intersection area IA. In a case where it is determined in S11 that the obstacle vehicle Ao is present in the intersection area IA, a peeking control process (see FIG. 11) is performed in S12.

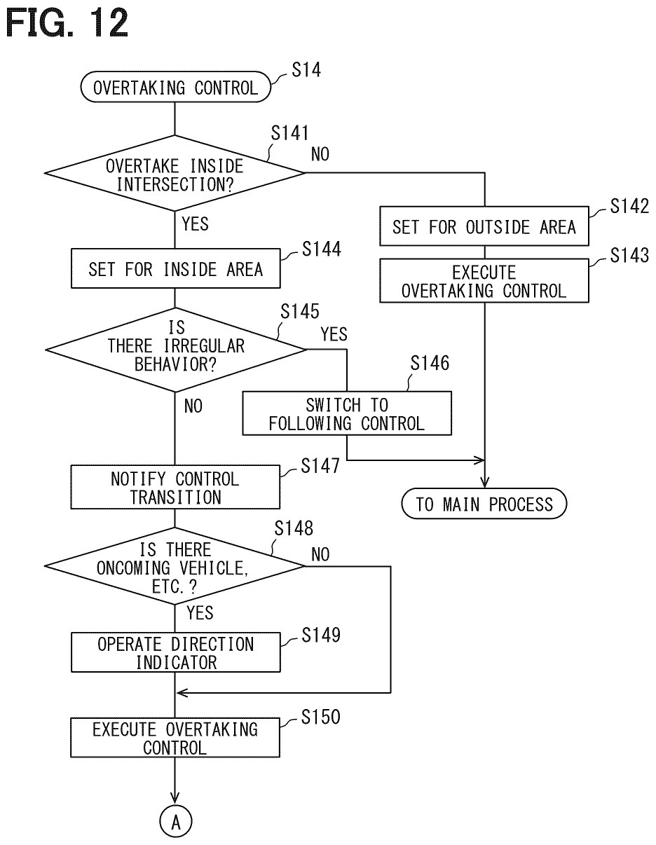

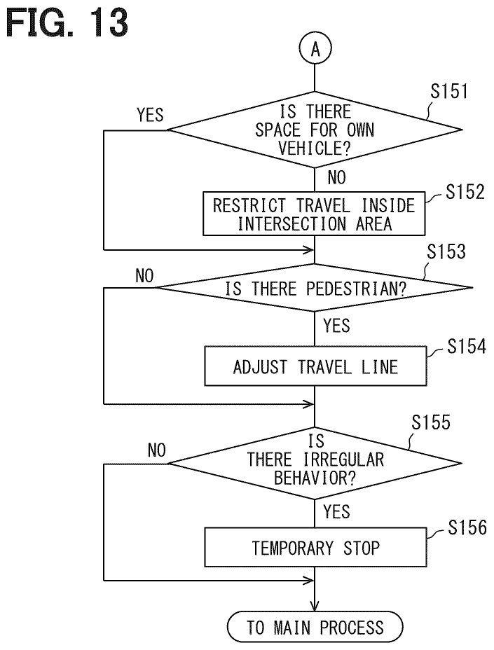

In S13, the travel control section 76 determines whether a transition from the peeking control to the overtaking control is possible. The permission criterion for permitting the transition to the overtaking control is changed according to the remaining distance to the intersection area IA. In a case where the situation ahead of the obstacle vehicle Ao is checked in the peeking control process and it is determined that the transition from the peeking control to the overtaking control is possible (S13: YES), the overtaking control process (see FIGS. 12 and 13) is performed in S14.

On the other hand, in a case where control suspension is determined in the peeking control process (see S131 in FIG. 11), or in a case where there is a plurality of obstacle vehicles Ao near the intersection area IA (see scene 6 in FIG. 8), the travel control section 76 determines that it is not possible to transition from the peeking control to the overtaking control. In a case where it is determined that the it is not possible to transition to the overtaking control (S13: NO), the travel control section 76 determines to suspend the overtaking control in S15. In accordance with the determination in S15, a surroundings monitoring execution request, a driving-mode switch request, or the like may be made to the driver.

In the peeking control process illustrated in FIG. 11, the content of the peeking control is changed according to the information related to the intersection area IA. Specifically, in S121 of the peeking control process, it is determined whether the subject vehicle Am is in the intersection area IA. Based on the determination in S121, the content of the peeking control is changed between in a case where the peeking control is performed inside the intersection area IA and in a case where the peeking control is performed outside the intersection area IA.

In a case where the subject vehicle Am is located in the intersection area IA (S121: YES, see the scene 4 in FIG. 6), the travel control section 76 applies the setting for inside the intersection area IA in S122. The inter-vehicle distance VD from the subject vehicle Am to the obstacle vehicle Ao in the peeking control is made longer in the setting for inside the intersection area IA, than in the setting for outside the intersection area IA. Further, in the setting for inside the intersection area IA, the temporary stop in a case where the peeking control is performed is omitted.

On the other hand, in a case where the subject vehicle Am is located outside the intersection area IA (S121: NO, see the scene 1 in FIG. 3), the travel control section 76 applies the setting for outside the intersection area IA in S123. The inter-vehicle distance VD from the subject vehicle Am to the obstacle vehicle Ao in the peeking control is made shorter in the setting for outside the intersection area IA than in the setting for inside the intersection area IA. Further, in the setting for outside the intersection area IA, the temporary stop is performed in a case where the peeking control is performed.

In S124, it is determined whether the traffic signal TL is installed in the intersection area IA. In a case where the traffic signal TL is installed in the intersection area IA (S124: YES), the travel control section 76 permits the execution of the peeking control. On the other hand, in a case where the traffic signal TL is not installed in the intersection area IA (S124: NO), the travel control section 76 restricts execution of the peeking control in S131. Specifically, in S131, suspension of the peeking control and the overtaking control is determined.

In S125, the presence or absence of the following vehicle Ab is determined. The travel control section 76 changes content of the peeking control according to the presence or absence of the following vehicle Ab. In a case where there is no following vehicle Ab (S125: NO), the travel control section 76 performs peeking control in S130. On the other hand, in a case where the following vehicle Ab is present (S125: YES), information about the following vehicle Ab is grasped in S126.

In S127, it is determined whether there is a possibility of overtaking the subject vehicle Am with respect to the following vehicle Ab (see the scene 5 in FIG. 7) traveling in the subject vehicle lane Lns. In a case where it is determined in S127 that the following vehicle Ab is present in the subject vehicle lane Lns and there is a possibility of the following vehicle Ab performing overtaking (S127: YES), the execution of the peeking control is restricted. Specifically, the start of the peeking control is suspended by repetition of S125 to S127. In a case where there is a possibility of the following vehicle Ab performing overtaking, the travel control section 76 may determine to suspend the peeking control and the overtaking control in S131.

In S128, it is determined whether there is a following vehicle Ab (see the scene 4 in FIG. 6) traveling in the adjacent lane Lnd. In a case where there is no following vehicle Ab traveling in the adjacent lane Lnd (S128: NO), the travel control section 76 performs peeking control in S130. On the other hand, in a case where there is a following vehicle Ab traveling in the adjacent lane Lnd (S128: YES), the travel control section 76 adjusts the behavior of the peeking control in S129.

Specifically, in S129, the look-in amount of the subject vehicle Am in the peeking control is suppressed. In addition, in S129, the inter-vehicle distance VD from the subject vehicle Am to the obstacle vehicle Ao is adjusted to be long. In S129, as the relative speed of the following vehicle Ab decreases, the look-in amount of the subject vehicle Am in the peeking control increases. The travel control section 76 reflects the adjustment in S129 and performs peeking control in S130. After starting the peeking control in S130, in a case where it is determined that there is a possibility of the following vehicle Ab traveling in the subject vehicle lane Lns performing overtaking, the travel control section 76 suspends the peeking control.

In the overtaking control process illustrated in FIGS. 12 and 13, the content of the overtaking control is changed according to the information related to the intersection area IA. Specifically, in S141 of the overtaking control process, it is determined whether the intersection area IA is included in the section where execution of the overtaking control is scheduled. Based on the determination in S141, the content of the overtaking control is changed between in a case where the overtaking control is performed in a section including the intersection area IA and in a case where the overtaking control is performed in a section not including the intersection area IA.

In a case where the intersection area IA is not included in the section where the overtaking control is scheduled to be performed (S141: NO), the travel control section 76 applies the setting for outside the intersection area IA in S142. The upper limit of the traveling speed of the subject vehicle Am in the overtaking control is relaxed in the setting for outside the intersection area IA, compared with in the setting for inside the intersection area IA. Furthermore, the degree of curved movement of the subject vehicle Am to the direction away from the obstacle vehicle Ao is made smaller in the setting for outside the intersection area IA than in the setting for inside the intersection area IA. The travel control section 76 performs the overtaking control in S143 based on the setting applied in S142.

In a case where the intersection area IA is included in the section where execution of the overtaking control is scheduled (S141: YES), the travel control section 76 applies the setting for inside the intersection area IA in S144. The traveling speed of the subject vehicle Am in the overtaking control is suppressed in the setting for inside the intersection area IA, compared with in the setting for outside the intersection area IA. Furthermore, the degree of curved movement of the subject vehicle Am in the direction away from the obstacle vehicle Ao is made larger in the setting for inside the intersection area IA than in the setting for outside the intersection area IA.

In S145, the presence or absence of the irregular behavior of the obstacle vehicle Ao is determined. In a case where the irregular behavior of the obstacle vehicle Ao is grasped in S145 (S145: YES), the travel control section 76 causes the subject vehicle Am to follow the obstacle vehicle Ao ahead and start in S146. On the other hand, in a case where the irregular behavior of the obstacle vehicle Ao is not grasped (S145: NO), a control transition notification indicating a control transition to the overtaking control is performed for the occupant in the vehicle in S147. The control transition notification may be performed at the start of the overtaking control (S143) in a case where the intersection area IA is not included in the section where execution of the overtaking control is scheduled.

In S148, the presence or absence of the oncoming vehicle Ac and the following vehicle Ab is determined. In a case where the oncoming vehicle Ac or the following vehicle Ab is present (S148: YES), the device control section 65 determines the operation of the direction indicator 44 in the overtaking control in S149. On the other hand, in a case where the oncoming vehicle Ac and the following vehicle Ab are not present (S148: NO), the operation of the direction indicator 44 is omitted. In S150, the travel control section 76 performs the overtaking control reflecting the setting in S144.

In S151, the environment recognition section 62 determines whether there is a space for the subject vehicle Am ahead of the intersection area IA before the subject vehicle Am enters the intersection area IA. In a case where there is not a space for the subject vehicle Am (S151: NO), the travel control section 76 suppresses the traveling speed of the subject vehicle Am in the overtaking control or temporarily stops the subject vehicle Am before the intersection area IA in S152 (see scene 2 in FIG. 4).

In S153, the environment recognition section 62 determines whether there is a pedestrian Pd in the waiting area WA. In a case where the pedestrian Pd is present in the waiting area WA (S153: YES), in S154, the travel control section 76 adjusts the travel line in the overtaking control to increase the degree of curved movement of the subject vehicle Am to the direction away from the pedestrian Pd (see the scene 3 in FIG. 5).

In S155, the environment recognition section 62 determines the presence or absence of the irregular behavior of the obstacle vehicle Ao. In a case where the irregular behavior of the obstacle vehicle Ao is grasped (S155: YES), the travel control section 76 temporarily stops the subject vehicle Am in S156 (see the scene 7 in FIG. 9). In this case, the travel control section 76 waits for the obstacle vehicle Ao to leave the intersection area IA and then resumes traveling toward the subject vehicle Am.

### Overview of First Embodiment

In the first embodiment described so far, content of at least one of the peeking control for moving the subject vehicle Am so as to look into the situation ahead of the obstacle vehicle Ao and the overtaking control for overtaking the obstacle vehicle Ao is changed according to the information grasped in relation to the intersection area IA. Therefore, even in the intersection area IA, the subject vehicle Am can appropriately avoid the obstacle vehicle Ao that obstructs traveling of the subject vehicle Am while continuing the automated driving. Therefore, convenience of automated driving can be ensured.

In addition, in the first embodiment, the content of the peeking control is changed between in a case where the peeking control is performed inside the intersection area IA and in a case where the peeking control is performed outside the intersection area IA. Therefore, in each of the inside and the outside of the intersection area IA, the peeking control can move the subject vehicle Am to a position where the driver or the surroundings monitoring sensor 30 can appropriately grasp the situation ahead of the obstacle vehicle Ao.

In the first embodiment, the inter-vehicle distance VD from the subject vehicle Am to the obstacle vehicle Ao in the peeking control is changed between in a case where the peeking control is performed in the intersection area IA and in a case where the peeking control is performed outside the intersection area IA. Therefore, in each of the inside and the outside of the intersection area IA, the peeking control can move the subject vehicle Am to a position where grasping of the surroundings situation by the driver or the surroundings monitoring sensor 30 is hardly hindered by the obstacle vehicle Ao.

Furthermore, in the first embodiment, the inter-vehicle distance VD from the subject vehicle Am to the obstacle vehicle Ao is made longer in a case where the peeking control is performed in the intersection area IA than in a case where the peeking control is performed outside the intersection area IA. The importance of monitoring in the left-right direction is higher in the intersection area IA than outside the intersection area IA. Therefore, by securing the inter-vehicle distance VD to the obstacle vehicle Ao in the intersection area IA, the range where the driver or the surroundings monitoring sensor 30 can perform surroundings monitoring is less likely to be narrowed by the obstacle vehicle Ao.

In addition, in the first embodiment, in a case where the peeking control is performed outside the intersection area IA, the subject vehicle Am is temporarily stopped. Therefore, the uneasiness of the occupant at the time of transition to the peeking control can be reduced. On the other hand, in a case where the peeking control is performed in the intersection area IA, the temporary stop is omitted. In this way, when the peeking control is immediately executed in the intersection area IA, the subject vehicle Am can quickly exit from the intersection area IA while avoiding the obstacle vehicle Ao.

In the first embodiment, the following vehicle Ab traveling behind the subject vehicle Am is grasped, and the content of the peeking control is changed according to the presence or absence of the following vehicle Ab. Therefore, while reducing the risk of the following vehicle Ab, the subject vehicle Am can move to a position where the driver or the surroundings monitoring sensor 30 can appropriately grasp the situation ahead of the obstacle vehicle Ao.

Furthermore, in the first embodiment, the look-in amount of the subject vehicle Am in the peeking control is suppressed in a case where the following vehicle Ab is present in the moving side adjacent lane Lnd where the subject vehicle Am moves in the peeking control, compared with in a case where the following vehicle Ab is present in the subject vehicle lane Lns where the subject vehicle Am travels. Therefore, a situation in which the subject vehicle Am having moved to the adjacent lane Lnd by the peeking control obstructs the traveling of the following vehicle Ab traveling in the adjacent lane Lnd is not likely to occur.

In addition, in the first embodiment, the inter-vehicle distance VD from the subject vehicle Am to the obstacle vehicle Ao is made long in a case where the following vehicle Ab is present in the moving side adjacent lane Lnd where the subject vehicle Am moves by the peeking control, compared with in a case where the following vehicle Ab is present in the subject vehicle lane Lns in which the subject vehicle Am travels. As described above, by ensuring the inter-vehicle distance VD, even when the look-in amount is suppressed, the range where the driver or the surroundings monitoring sensor 30 can perform surroundings monitoring is less likely to be narrowed by the obstacle vehicle Ao.

In the first embodiment, the relative speed of the following vehicle Ab with respect to the subject vehicle Am is grasped, and the smaller the relative speed, the more the look-in amount of the subject vehicle Am in the peeking control is increased. According to such control, it is possible to suppress the uneasiness of the occupant with respect to the following vehicle Ab and to secure the look-in amount.

Furthermore, in the first embodiment, in a case where the following vehicle Ab is present in the subject vehicle lane Lns in which the subject vehicle Am travels, it is determined whether there is a possibility that the following vehicle Ab will overtake the subject vehicle Am. In a case where it is determined that there is a possibility of the following vehicle Ab performing overtaking, the execution of the peeking control is restricted. Therefore, a situation in which the movement of the following vehicle Ab is hindered by the execution of the peeking control is not likely to occur.

In addition, in the first embodiment, in a case where it is determined that there is a possibility that the following vehicle Ab overtakes the subject vehicle Am after the start of the peeking control, the peeking control is suspended. According to such suspension of the peeking control, the occupant can recognize that the behavior of the following vehicle Ab is grasped by the system. Therefore, it is possible to increase the reliability of the occupant with respect to the peeking control.

In the first embodiment, whether the traffic signal TL is installed in the intersection area IA is grasped. In a case where the traffic signal TL is installed in the intersection area IA, the peeking control is performed, and in a case where the traffic signal TL is not installed in the intersection area IA, the execution of the peeking control is restricted. In this manner, the difficulty level of automated driving in the intersection area IA changes depending on the presence or absence of the traffic signal TL. Therefore, it is desirable that the execution of the peeking control is restricted in the intersection area IA without the traffic signal TL in which the difficulty level of automated driving is high.

Further, in the first embodiment, the state of the traffic signal TL installed in the intersection area IA is grasped. In a case where the traffic signal TL is in the yellow lighting state, the execution of the peeking control is restricted. Therefore, it is possible to avoid a situation in which peeking control is forcibly started in a state in which it is difficult to pass through the intersection area IA.

In addition, in the first embodiment, the preceding vehicle Af located in front of the subject vehicle Am is grasped in the intersection area IA. In a case where the preceding vehicle Af is moving, the execution of the peeking control in which the preceding vehicle Af is set as the obstacle vehicle Ao is restricted. When the execution of the peeking control is cancelled as described above, the subject vehicle Am can exit from the intersection area IA in a state where the recognition of the region ahead is not hindered by the obstacle vehicle Ao after the disappearance of the preceding vehicle Af (obstacle vehicle Ao) waiting for the right turn.

In the first embodiment, the content of the overtaking control is changed between in a case where the overtaking control is performed in a section including the intersection area IA and in a case where the overtaking control is performed in a section not including the intersection area IA. Therefore, the overtaking control can appropriately avoid the obstacle vehicle Ao inside and outside the intersection area IA.

Furthermore, in the first embodiment, the traveling speed of the subject vehicle Am in the overtaking control is suppressed in a case where the overtaking control is performed in the section including the intersection area IA, compared with in a case where the overtaking control is performed in the section not including the intersection area IA. Therefore, the uneasiness of the occupant in a case where the overtaking control is performed in the section including the intersection area IA can be suppressed.

In addition, in the first embodiment, it is determined whether there is a space for the subject vehicle Am ahead of the intersection area IA before the subject vehicle Am enters the intersection area IA. The traveling speed of the subject vehicle Am in the overtaking control is suppressed in a case where there is not the space, compared with in a case where there is a space. According to such control, the subject vehicle Am can smoothly move after the preceding vehicle located ahead of the intersection area IA.

In the first embodiment, in a case where there is not the space ahead of the intersection area IA, the entry of the subject vehicle Am into the intersection area IA is restricted in the overtaking control. Therefore, a situation in which the subject vehicle Am cannot escape from the intersection area IA by the overtaking control is not likely to occur.

Furthermore, in the first embodiment, the degree of curved movement of the subject vehicle Am to the direction away from the obstacle vehicle Ao to be overtaken is larger in a case where the overtaking control is performed in the section including the intersection area IA, than in a case where the overtaking control is performed in the section not including the intersection area IA. Since no section line is provided in the intersection area IA, a large curved movement is likely to be allowed. In addition, by moving away from the obstacle vehicle Ao, the detection range of the surroundings monitoring sensor 30 is less likely to be narrowed by the obstacle vehicle Ao.

In addition, in the first embodiment, it is grasped whether a pedestrian Pd is present in the waiting area WA facing the intersection area IA. The degree of curved movement of the subject in the direction away from the pedestrian Pd is increased by the overtaking control in a case where the pedestrian Pd is present in the waiting area WA, compared with in a case where the pedestrian Pd is not present in the waiting area WA. Thus, the pedestrian Pd is less likely to feel uneasy about the subject vehicle Am that performs the overtaking control in the intersection area IA.

In the first embodiment, the irregular behavior of the obstacle vehicle Ao located in the intersection area IA is grasped. In a case where the irregular behavior is grasped after the start of the overtaking control, the subject vehicle Am temporarily stops. In addition, in a case where the irregular behavior is grasped before the overtaking control is started, the subject vehicle Am follows the obstacle vehicle Ao. According to such control, the subject vehicle Am can appropriately avoid the obstacle vehicle Ao exhibiting the irregular behavior.

Further, in the first embodiment, the oncoming vehicle Ac traveling on the opposite lane Lno is grasped in the intersection area IA. In a case where the oncoming vehicle Ac is present in the opposite lane Lno, the direction indicator 44 of the subject vehicle Am operate in accordance with the overtaking control. On the other hand, in a case where the oncoming vehicle Ac is not present in the opposite lane Lno, the operation of the direction indicator 44 associated with the overtaking control is omitted. According to the above, it is possible to appropriately transmit the behavior of the subject vehicle Am to the oncoming vehicle Ac in a scene where the oncoming vehicle Ac is present while suppressing botheration due to the operation of the direction indicator 44.

In addition, in the first embodiment, the remaining distance from the subject vehicle Am to the intersection area IA is grasped. The permission criterion for permitting the transition from the peeking control to the overtaking control is changed according to the remaining distance. According to such adjustment of the permission criterion, it is possible to achieve both the reduction in the risk of the overtaking control and the securing of convenience.

In the first embodiment, when a plurality of obstacle vehicles Ao is grasped after the start of the peeking control, the transition to the overtaking control is permitted in a case where the remaining distance exceeds a predetermined distance. On the other hand, in a case where the remaining distance does not exceed the predetermined distance, the transition to the overtaking control is not permitted. According to such control, it is possible to avoid execution of high risk overtaking control in which the subject vehicle overtakes the plurality of obstacle vehicles Ao in the vicinity of the intersection area IA.

In the first embodiment described above, the environment recognition section 62 corresponds to an “information grasping section”, the obstacle vehicle Ao corresponds to an “obstacle” and a “preceding vehicle”, the inter-vehicle distance VD corresponds to a “distance”, and the automated driving ECU 50 corresponds to an “automated driving control device”.

### Second Embodiment

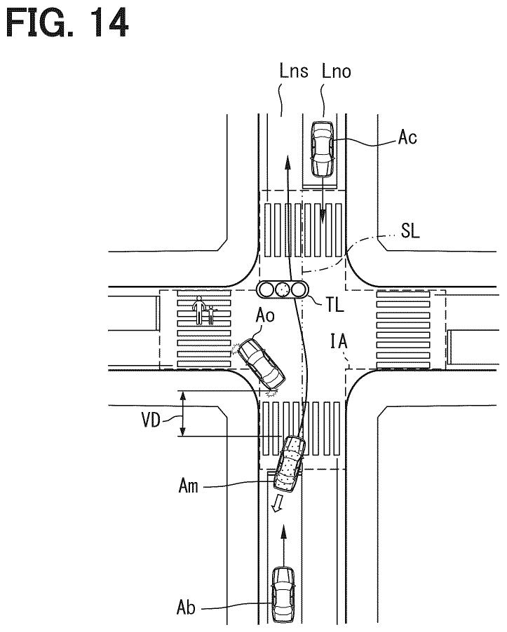

The second embodiment of the present disclosure is a modification of the first embodiment. In addition to the scenes 1 to 7 of the first embodiment, the automated driving ECU 50 according to the second embodiment performs intersection travel control including peeking control in an intersection area IA of the scenes 8 to 12 described later. Hereinafter, details of the intersection travel control performed in the scene 8 to 12 will be described with reference to FIGS. 1 and 2 based on FIGS. 14 to 18.

(Scene 8: Oncoming Vehicle Avoidance Scene on Road with One Lane on Each Side)

In the scene 8 illustrated in FIG. 14, the subject vehicle Am is traveling on a road with one lane on each side including the subject vehicle lane Lns and the opposite lane Lno. In the subject vehicle lane Lns, there is a following vehicle Ab that follows the subject vehicle Am. There is an oncoming vehicle Ac traveling toward the intersection area IA in the opposite lane Lno. The automated driving ECU 50 performs peeking control and overtaking control for avoiding the obstacle vehicle Ao waiting for a left turn in the intersection area IA.

The environment recognition section 62 grasps whether the road on which the subject vehicle Am is traveling is a road with one lane on each side. The environment recognition section 62 grasps the state of the traffic signal TL installed in the intersection area IA, specifically, the lighting pattern of the traffic signal TL. The environment recognition section 62 grasps the following vehicle Ab traveling behind the subject vehicle Am and oncoming vehicle Ac traveling in opposite lane Lno.

In a case where the subject vehicle Am is traveling on a road with one lane on each side, the travel control section 76 performs peeking control in which the subject vehicle is out of the subject vehicle lane Lns and peeking control in which the subject vehicle stays in the subject vehicle lane Lns. The peeking control in which the subject vehicle is out of the subject vehicle lane Lns is travel control is travel control in which the right front portion of the subject vehicle Am is out of its lane into the opposite lane Lno over a virtual section line SL (see one-dot chain line in FIG. 14) that divides the subject vehicle lane Lns and the opposite lane Lno.

The travel control section 76 switches between the peeking control in which the subject vehicle is out of the subject vehicle lane Lns and the peeking control in which the subject vehicle stays in the subject vehicle lane Lns according to the position of the obstacle vehicle Ao. In a case where most of the obstacle vehicle Ao remains in the subject vehicle lane Lns, the travel control section 76 allows the peeking control in which the subject vehicle is out of the subject vehicle lane Lns. On the other hand, in a case where most of the obstacle vehicle Ao is located on the exit road beyond a left turn, the travel control section 76 prohibits the peeking control in which the subject vehicle is out of the subject vehicle Am. The travel control section 76 changes content of the vehicle control between the peeking control in which the subject vehicle is out of the subject vehicle lane Lns and the peeking control in which the subject vehicle stays in the subject vehicle lane Lns.

The travel control section 76 makes the inter-vehicle distance VD from the subject vehicle Am to the obstacle vehicle Ao longer in a case where the peeking control in which the subject vehicle is out of the subject vehicle lane Lns is performed than in a case where the peeking control in which the subject vehicle stays in the subject vehicle lane Lns is performed. In other words, the travel control section 76 performs peeking control in which the subject vehicle is out of the subject vehicle lane Lns in a state where a space is secured between the subject vehicle and the obstacle vehicle Ao in front of the subject vehicle.

In a case where the oncoming vehicle Ac is grasped by the peeking control in which the subject vehicle is out of the subject vehicle lane Lns, the travel control section 76 performs avoidance control for avoiding the oncoming vehicle Ac. As the avoidance control, the travel control section 76 moves the subject vehicle Am backward toward the subject vehicle lane Lns. In a case where the following vehicle Ab is not grasped, the travel control section 76 moves the subject vehicle Am backward until the subject vehicle Am exits from the intersection area IA. On the other hand, in a case where the following vehicle Ab is grasped, the travel control section 76 moves the subject vehicle Am backward so that the entire subject vehicle Am retreats from the area on the opposite lane Lno side within a range in which the subject vehicle does not contacting the following vehicle Ab.

Even in a case where the oncoming vehicle Ac is grasped by the peeking control in which the subject vehicle stays in the subject vehicle lane Lns, the travel control section 76 performs the avoidance control for avoiding the oncoming vehicle Ac. In a case where the following vehicle Ab is not grasped, the travel control section 76 moves the subject vehicle Am backward until the subject vehicle Am exits from the intersection area IA, as in a case where the peeking control in which the subject vehicle is out of the subject vehicle lane Lns is performed. On the other hand, in a case where the following vehicle Ab is grasped, the travel control section 76 restricts execution of the avoidance control. In this case, the travel control section 76 stops the backward movement of the subject vehicle Am by the avoidance control and causes the subject vehicle Am to stay at the current position.

After the start of the peeking control and before the start of the overtaking control, the travel control section 76 starts the avoidance control in a case where the traffic signal TL in front of the subject vehicle changes from a blue light to a yellow light. Also in the avoidance control in this case, the travel control section 76 moves the subject vehicle Am backward toward the subject vehicle lane Lns. Also in the avoidance control caused by the transition to the yellow signal, in a case where the following vehicle Ab is not grasped, the travel control section 76 moves the subject vehicle Am backward until the subject vehicle Am exits from the intersection area IA.

(Scene 9: Scene of Evacuation from Intersection Area)

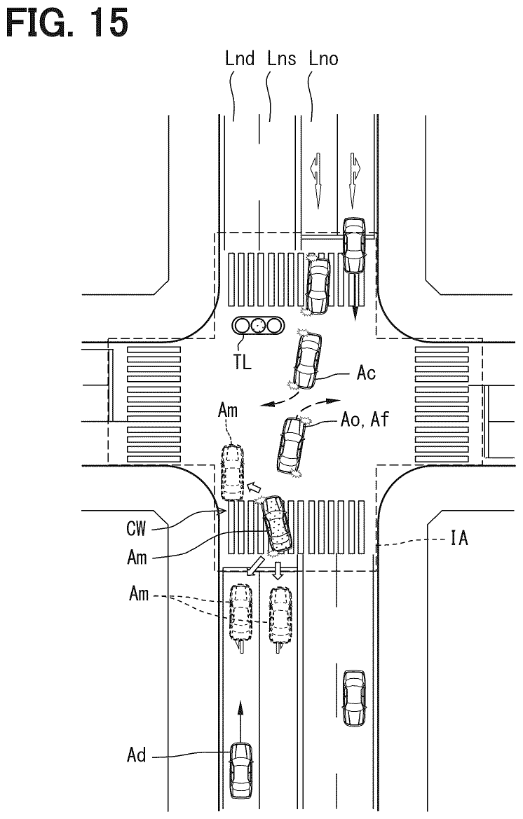

In the scene 9 illustrated in FIG. 15, the subject vehicle Am is traveling on a road with a plurality of lanes on one side including the subject vehicle lane Lns and the adjacent lane Lnd, and two opposite lanes Lno. Its subject vehicle Am is traveling in the right lane of the two lanes. In the adjacent lane Lnd, there is a following vehicle Ad traveling toward the intersection area IA. In the intersection area IA, the preceding vehicle Af and the oncoming vehicle Ac are waiting for the right turn. The automated driving ECU 50 sets the preceding vehicle Af waiting for the right turn in the intersection area IA as an obstacle vehicle Ao, and performs peeking control and overtaking control for avoiding the obstacle vehicle Ao.

The environment recognition section 62 grasps whether the road on which the subject vehicle Am is traveling is a road with a plurality of lanes on one side. The environment recognition section 62 grasps the state (lighting pattern) of the traffic signal TL installed in the intersection area IA. The environment recognition section 62 grasps the presence of the following vehicle Ad traveling in the adjacent lane Lnd. In a case of grasping the presence of the following vehicle Ad, the environment recognition section 62 further grasps the relative position and the relative speed of the following vehicle Ad with respect to the subject vehicle Am.

In a case where the traffic signal TL changes from a blue light to a yellow light while the peeking control is being performed in the intersection area IA of a road with a plurality of lanes on one side, the travel control section 76 evacuates the subject vehicle Am from the current position. Travel control section 76 moves the subject vehicle Am from the crosswalk CW to an area outside the crosswalk CW. In a case where the following vehicle Ad is not present in the adjacent lane Lnd, the travel control section 76 permits the subject vehicle Am to evacuated to the adjacent lane Lnd outside the intersection area IA. In this case, the travel control section 76 moves the subject vehicle Am backward to a position before the stop line of the adjacent lane Lnd.

On the other hand, in a case where the following vehicle Ad is present in the adjacent lane Lnd and the following vehicle Ad approaches the intersection area IA at a predetermined speed or more, the travel control section 76 evacuates the subject vehicle Am to the subject vehicle lane Lns outside the intersection area IA. As an example, in a case where the traffic signal TL transitions to the yellow lighting state and the following vehicle Ad suddenly accelerates, the travel control section 76 sets the evacuation place of the subject vehicle Am to the subject vehicle lane Lns. The travel control section 76 moves the subject vehicle Am backward to a position before the stop line of the subject vehicle lane Lns.

In a case where the relative speed of the following vehicle Ad is less than the predetermined speed, the travel control section 76 evacuates the subject vehicle Am to the adjacent lane Lnd in the intersection area IA. As an example, the travel control section 76 moves the subject vehicle Am to a region of the adjacent lane Lnd ahead of the crosswalk CW. In addition, even in a case where the following vehicle Ad has already stopped near the stop line of the adjacent lane Lnd, the travel control section 76 moves the subject vehicle Am to the region of the adjacent lane Lnd ahead of the crosswalk CW.

### (Scene 10: Overtaking Scene in Complex Travel Environment)

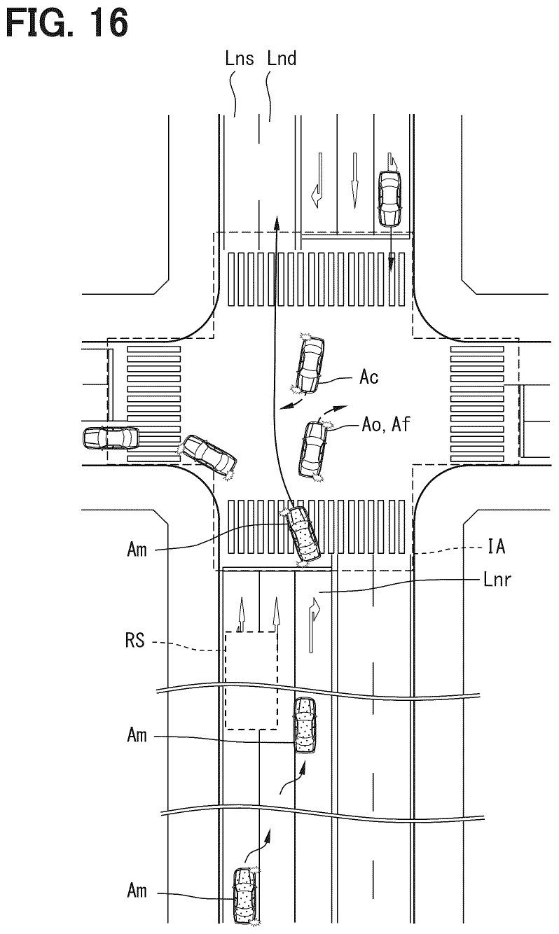

In the scene 10 illustrated in FIG. 16, a non-travelable area RS is generated before the intersection area IA. The non-travelable area RS is an area in which traveling is restricted due to, for example, an accident, road construction, or the like. The non-travelable area RS is set across both the subject vehicle lane Lns and the adjacent lane Lnd. The automated driving ECU 50 performs a plurality of lane movements before the subject vehicle Am reaches the non-travelable area RS. Specifically, the automated driving ECU 50 performs a first lane change of moving the subject vehicle Am from the subject vehicle lane Lns to the adjacent lane Lnd and a second lane change of moving the subject vehicle Am from the adjacent lane Lnd to a right turn lane Lnr.

In the intersection area IA, the preceding vehicle Af and the oncoming vehicle Ac are waiting for the right turn. The automated driving ECU 50 sets the preceding vehicle Af waiting for the right turn in the intersection area IA as an obstacle vehicle Ao, and performs peeking control and overtaking control for avoiding the obstacle vehicle Ao.

The environment recognition section 62 grasps whether the non-travelable area RS occurs before and after the intersection area IA on the road where the subject vehicle Am travels. In a case where a plurality of lane movements is required before and after the intersection area IA by grasping the non-travelable area RS, the notification request section 72 cooperates with the HMI system 10 to notify the driver of the subject vehicle Am of information about the plurality of lane movements. Such lane movement notification is made with the screen display of the meter display 21, the CID 22, and the like. The HMI system 10 notifies the driver of presence of the non-travelable area RS and execution of a plurality of lane movements before arrival at the intersection area IA due to the non-travelable area RS by the lane movement notification. Further, in the lane movement notification, the driver is notified that there is no change in the route passing through the intersection area IA.

The travel control section 76 suppresses a look-in amount of the subject vehicle Am in the peeking control in a case where a plurality of lane movements is required before and after the intersection area IA, compared with in a case where a plurality of lane movements is not required. In view of the possibility that the inside of the intersection area IA and the vicinity of the intersection area IA are complicated travel environments due to the non-travelable area RS, the travel control section 76 carefully performs movement under peeking control for checking a situation ahead of the obstacle vehicle Ao (preceding vehicle Af).

The travel control section 76 starts overtaking control of overtaking the obstacle vehicle Ao based on confirmation of stop of the oncoming vehicle Ac by the peeking control. The travel control section 76 may evacuate the subject vehicle Am to the adjacent lane Lnd (right lane) or evacuate the subject vehicle Am to the subject vehicle lane Lns (left lane) by the overtaking control. Even in a case where the non-travelable area RS is generated ahead of the intersection area IA and a plurality of lane movements is required ahead of the intersection area IA, the travel control section 76 suppresses the look-in amount of the subject vehicle Am in the peeking control.

(Scene 11: Scene of Looking into Both Left and Right Sides)

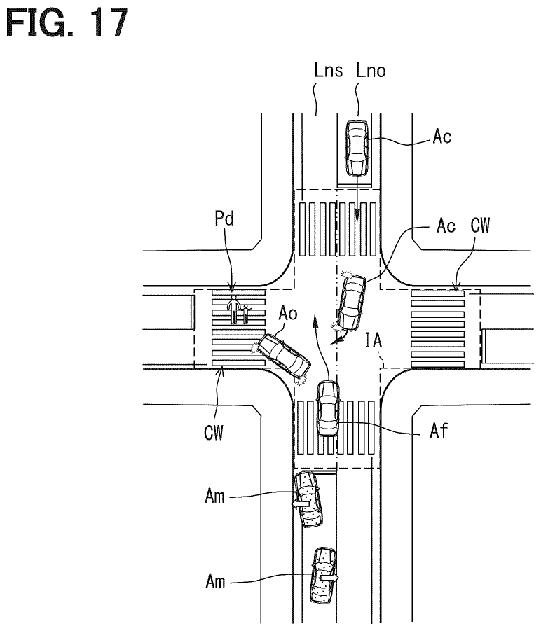

In the scene 11 illustrated in FIG. 17, the subject vehicle Am is traveling on a road with one lane on each side including the subject vehicle lane Lns and the opposite lane Lno. In the intersection area IA, the traffic signal TL (see FIG. 14) is not installed. In a region close to the subject vehicle lane Lns in the intersection area IA, there are the obstacle vehicle Ao waiting for a left turn and the preceding vehicle Af trying to overtake the obstacle vehicle Ao. There is the oncoming vehicle Ac waiting for the right turn in a region close to the opposite lane Lno of the intersection area IA. The automated driving ECU 50 performs peeking control and overtaking control for avoiding the obstacle vehicle Ao waiting for a left turn in the intersection area IA.

The travel control section 76 performs peeking control in a direction (left side) opposite an overtaking side direction (right side) in which the overtaking control is performed in the left-right direction of the subject vehicle Am. Specifically, in the scene 11, it is difficult to check the situation ahead of the obstacle vehicle Ao only by the peeking control in the overtaking side direction due to the obstruction by the preceding vehicle Af. In a case where the situation ahead of the obstacle vehicle Ao is not capable of being checked by the peeking control in the overtaking side direction, the travel control section 76 performs peeking control in the opposite direction. In a case where there is a preceding vehicle Af traveling rightward in the subject vehicle lane Lns, the travel control section 76 may omit the peeking control in the overtaking side direction and perform only the peeking control in the opposite direction. In a case where the situation ahead of the intersection area IA can be checked by the peeking control in the overtaking side direction, the travel control section 76 omits the peeking control in the opposite direction even in a scene where the preceding vehicle Af is present.

The travel control section 76 determines whether to perform peeking control in the opposite direction according to the lane width of the subject vehicle lane Lns grasped by the environment recognition section 62. In a case where the lane width of the subject vehicle lane Lns is narrower than the predetermined width, the travel control section 76 performs peeking control in the opposite direction. According to the above, another oncoming vehicle Ac or the like approaching the intersection area IA can be grasped from the gap between the preceding vehicle Af and the obstacle vehicle Ao present in the intersection area IA.

In a case where no traffic signal is installed in the intersection area IA, the travel control section 76 performs both peeking control in the overtaking side direction and peeking control in the opposite direction. According to such peeking control on the left and right sides, the environment recognition section 62 can check both the situations of the left and right intersecting roads intersecting with the subject vehicle lane Lns and the opposite lane Lno. The environment recognition section 62 grasps the situation of the pedestrian Pd crossing the crosswalk CW, the presence or absence of another vehicle traveling on the intersecting road toward the intersection area IA, and the like.

### (Scene 12: Scene in Right Turn Execution in Intersection Area)

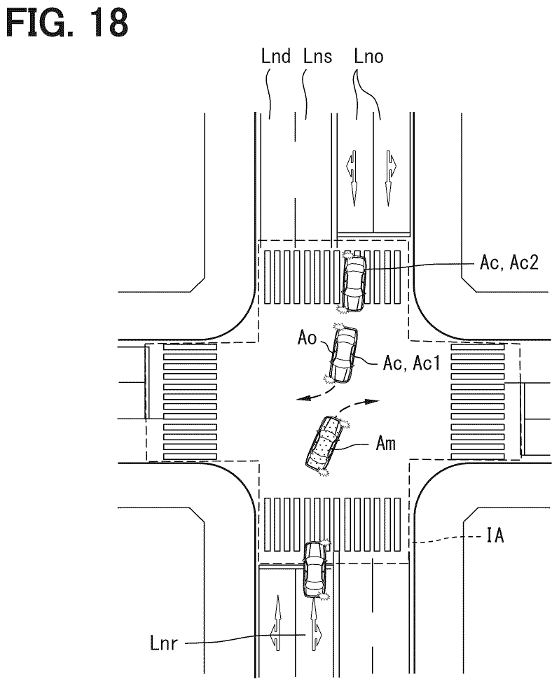

In the scene 12 illustrated in FIG. 18, the subject vehicle Am waits for a right turn in a region corresponding to the right turn lane Lnr in the intersection area IA. In the intersection area IA, the oncoming vehicle Ac (hereinafter, first oncoming vehicle Ac1) located in front of the subject vehicle Am waits for a right turn. Further, another oncoming vehicle Ac (hereinafter, second oncoming vehicle Ac2) following the first oncoming vehicle Ac1 is waiting for the right turn behind the first oncoming vehicle Ac1. The automated driving ECU 50 sets the first oncoming vehicle Ac1 in front as the obstacle vehicle Ao, and performs peeking control for checking a situation ahead of the obstacle vehicle Ao and intersection exit control for crossing the opposite lane Lno.

In a case where the subject vehicle Am turns right in the intersection area IA, the environment recognition section 62 grasps the first oncoming vehicle Ac1 and the second oncoming vehicle Ac2. The travel control section 76 moves the subject vehicle Am so as to look into the situation of the opposite lane Lno ahead of the first oncoming vehicle Ac1 (obstacle vehicle Ao) as the peeking control in a scene where the subject vehicle Am crosses the opposite lane Lno with a right turn.

The travel control section 76 changes the look-in amount of the subject vehicle Am in the peeking control according to whether the second oncoming vehicle Ac2 is present. The travel control section 76 increases the look-in amount of the subject vehicle Am moving rightward beyond the obstacle vehicle Ao in a case where the second oncoming vehicle Ac2 is present, compared with in a case where the second oncoming vehicle Ac2 is not present. In addition, the travel control section 76 slows the moving speed of the subject vehicle Am in the peeking control in a case where the second oncoming vehicle Ac2 is not present, compared with in a case where the second oncoming vehicle Ac2 is present. Furthermore, the travel control section 76 gradually moves the subject vehicle Am forward by repeating start and temporary stop without performing continuous movement in the peeking control at the time of waiting for the right turn. In a case where it is confirmed by the peeking control that there is no oncoming vehicle Ac traveling straight in the intersection area IA, the travel control section 76 switches from the peeking control to the intersection exit control and evacuates the subject vehicle Am the intersection area IA.

### Overview of Second Embodiment

Also in the second embodiment described above, the content of the peeking control for moving the subject vehicle Am so as to look into the situation ahead of the obstacle vehicle Ao is changed. Thus, the subject vehicle Am can appropriately avoid the obstacle vehicle Ao while continuing the automated driving in the intersection area IA. Therefore, convenience of automated driving can be ensured.

In addition, in the second embodiment, the peeking control is performed in a direction opposite the overtaking side direction in which the overtaking control is performed in the left-right direction of the subject vehicle Am. According to such peeking control in the opposite direction, the situation ahead of the obstacle vehicle Ao can be checked in various scenes.

In addition, in the second embodiment, in a case where the situation ahead of the obstacle vehicle Ao is not capable of being checked by the peeking control in the overtaking side direction, the peeking control in the opposite direction is performed. As described above, when the peeking control on the left and right sides is sequentially performed, the automated driving ECU 50 can more reliably grasp the situation ahead of the obstacle vehicle Ao.

Furthermore, in the second embodiment, it is determined whether to perform peeking control in the opposite direction in accordance with the lane width of the subject vehicle lane Lns in which the subject vehicle Am travels. Therefore, the peeking control in the opposite direction can be appropriately performed in a road environment effective for checking the situation ahead of the obstacle vehicle Ao.

In addition, in the second embodiment, in a case where the traffic signal TL is not installed in the intersection area IA, the peeking control in the overtaking side direction and the peeking control in the opposite direction are performed. Therefore, the automated driving ECU 50 can more reliably grasp the situation of the pedestrian Pd crossing the crosswalk CW of the intersecting road, the presence or absence of another vehicle on the intersecting road traveling toward the intersection area IA, and the like.

In addition, in the second embodiment, it is grasped whether the road on which the subject vehicle Am travels is a road with one lane on each side. In a case where the subject vehicle Am is traveling on a road with one lane on each side, the content of the vehicle control is changed between the peeking control in which the subject vehicle Am is out of the subject vehicle lane Lns and the peeking control in which the subject vehicle Am stays in the subject vehicle lane Lns. According to the above, since appropriate peeking control according to the traveling scene can be performed, the automated driving ECU 50 can more reliably grasp the check of the situation ahead of the obstacle vehicle Ao.

Further, in the second embodiment, the following vehicle Ab traveling behind the subject vehicle Am and the oncoming vehicle Ac traveling in the opposite lane Lno are grasped. In a case where the oncoming vehicle Ac is grasped by the peeking control in which the subject vehicle is out of the subject vehicle lane Lns, the avoidance control for avoiding the oncoming vehicle Ac is performed. On the other hand, even in a case where the oncoming vehicle Ac is grasped by the peeking control in which the subject vehicle stays in the subject vehicle lane Lns, the execution of the avoidance control is restricted in a case where the following vehicle Ab is grasped. According to the avoidance control described above, even when the peeking control is performed, the traveling of the oncoming vehicle Ac and the following vehicle Ab is less likely to be obstructed by the subject vehicle Am.

In addition, in the second embodiment, the avoidance control of moving the subject vehicle Am backward toward the subject vehicle lane Lns is performed. As described above, when the subject vehicle Am is returned to the subject vehicle lane Lns by the avoidance control, even when the peeking control in which the subject vehicle Am is out of the subject vehicle lane into the opposite lane Lno is performed, a situation in which traveling of the oncoming vehicle Ac is hindered by the subject vehicle Am is more unlikely to occur.

In the second embodiment, the avoidance control is started in a case where the traffic signal TL changes from a blue light to a yellow light. According to the above, the peeking control in the intersection area IA can be suspended at an appropriate timing.

Furthermore, in the second embodiment, the inter-vehicle distance VD from the subject vehicle Am to the obstacle vehicle Ao is made longer in a case where the peeking control in which the subject vehicle Am is out of the subject vehicle lane Lns is performed than in a case where the peeking control in which the subject vehicle stays in the subject vehicle lane Lns is performed. In this way, by securing a space in front of the subject vehicle Am in advance, it is possible to suppress the difficulty level of performing the avoidance control due to the suspension of the peeking control to be low.

In addition, in the second embodiment, it is grasped whether the road on which the subject vehicle Am travels is a road with a plurality of lanes on one side. In a case where the traffic signal TL changes from a blue light to a yellow light while the peeking control is performed in the intersection area IA of the road having a plurality of lanes on one side, the subject vehicle Am is evacuated from the subject vehicle lane Lns to the adjacent lane Lnd. When the traffic signal TL is in lighting state in yellow, the following vehicle Ad traveling in the adjacent lane Lnd normally decelerates, so that movement to the adjacent lane Lnd is facilitated. Thus, by evacuating the subject vehicle to the adjacent lane Lnd, the subject vehicle Am can smoothly pass through the intersection area IA after the traffic signal TL is in lighting state in blue again.

In the second embodiment, the following vehicle Ad traveling in the adjacent lane Lnd toward the intersection area IA is grasped. In a case where the traffic signal TL changes from a blue light to a yellow light while the peeking control is performed in the intersection area IA, and the following vehicle Ad approaches the intersection area IA at a predetermined speed or more, the subject vehicle Am is evacuated to the subject vehicle lane Lns. According to the above, in a case where the following vehicle Ad in the adjacent lane Lnd accelerates after the traffic signal TL is in lighting state in yellow, the subject vehicle Am avoids the following vehicle Ad and returns to the subject vehicle lane Lns. As a result, evacuation without hindering the movement of the following vehicle Ad can be achieved.

Further, in the second embodiment, in a case where a plurality of lane movements is required before and after the intersection area IA, information about the plurality of lane movements is notified to the driver of the subject vehicle Am by the lane movement notification. According to such a lane movement notification, the occupant such as the driver is less likely to feel uneasy about a plurality of lane movements. As a result, the convenience of automated driving felt by the driver can be further improved.

In addition, in the second embodiment, the look-in amount of the subject vehicle Am in the peeking control is suppressed in a case where a plurality of lane movements is required, compared with in a case where a plurality of lane movements is not required. In a scene where a plurality of lane movements is required before and after the intersection area IA, the travel environment in the intersection area IA and in the vicinity of the intersection area IA tends to be complicated. Therefore, by performing careful peeking control with a suppressed look-in amount and securing a high margin, it is possible to smoothly perform peeking control and overtaking control while suppressing uneasiness of the driver.

In the second embodiment, in a case where the subject vehicle Am turns right or left crossing the opposite lane Lno in the intersection area IA, the first oncoming vehicle Ac1 located in front of the subject vehicle Am and the second oncoming vehicle Ac2 following the first oncoming vehicle Ac1 are grasped. Under the peeking control in a scene where the subject vehicle Am crosses the opposite lane Lno, the subject vehicle Am is moved so as to look into the situation of the opposite lane Lno ahead of the first oncoming vehicle Ac1. Furthermore, the look-in amount of the subject vehicle Am in the peeking control is changed according to whether the second oncoming vehicle Ac2 is present. According to the above peeking control, even in the scene of turning right or left in which the subject vehicle crosses the opposite lane Lno, the situation of the opposite lane Lno ahead of the first oncoming vehicle Ac1 can be reliably grasped.

Further, in the second embodiment, the look-in amount in the peeking control is increased in a case where the second oncoming vehicle Ac2 is present, compared with in a case where the second oncoming vehicle Ac2 is not present. According to the above, even in a case where the second oncoming vehicle Ac2 is present, the situation of the oncoming vehicle Ac ahead of the second oncoming vehicle Ac2 can be reliably grasped.

In addition, the moving speed of the subject vehicle Am in the peeking control is made slow in the second embodiment, in a case where the second oncoming vehicle Ac2 is not present, compared with in a case where the second oncoming vehicle Ac2 is present. Therefore, even in a case where the second oncoming vehicle Ac2 is not present and another oncoming vehicle Ac traveling straight in the intersection area IA appears from behind the first oncoming vehicle Ac1, the subject vehicle Am can cope with the another oncoming vehicle Ac with a margin. In the second embodiment, the notification request section 72 corresponds to a “notification execution section”.

### OTHER EMBODIMENTS

Although a plurality of embodiments according to the present disclosure has been described above, the present disclosure is not to be construed as being limited to the above embodiments, and can be applied to various embodiments and combinations without departing from the gist of the present disclosure.

In the first modification of the above embodiment, the content of the peeking control is changed between in a case where the driver is obliged to monitor the surroundings and in a case where the driver is not obliged to monitor the surroundings. As an example, the travel control section 76 increases the look-in amount in a case where the driver is obliged to monitor the surroundings, compared with in a case where the driver is not obliged to monitor the surroundings. As a result, the driver can easily visually check the situation ahead of the obstacle vehicle Ao. Furthermore, the look-in amount in the peeking control may be changed according to an attachment position of an autonomous sensor mounted on the subject vehicle Am as the surroundings monitoring sensor 30.

In the above embodiment, the intersection area IA is a range surrounded by the stop line. However, the range of the intersection area may be, for example, a range inside the crosswalk. Furthermore, the form of the intersection is not limited to the cross as in the above embodiment. For example, the peeking control and the overtaking control may be performed at intersections of various forms such as a multi-way intersection (a six-way intersection or the like), a Y-shaped intersection, a T-shaped intersection, and an annular intersection (roundabout).

In the above embodiment, the content of the peeking control and the overtaking control have been described on the premise of the traffic environment where the vehicle travels on the left side. However, as described above, the traffic environment in which the vehicle travels may be a traffic environment on the premise of right-side traffic. The peeking control and the overtaking control may be appropriately changed in accordance with a traffic environment on the premise of right-side traffic. As described above, the automated driving control according to the present disclosure may be appropriately optimized according to the road traffic law of each country and region, the steering wheel position of the vehicle, and the like.

The obstacle to be controlled by the peeking control and the overtaking control is not limited to the obstacle vehicle Ao of the above embodiment. The automated driving ECU 50 can set an installation object or the like installed on a road inside or outside the intersection area IA as a target to be controlled by the peeking control and the overtaking control. Furthermore, the automated driving ECU 50 may change the content of the peeking control according to the type, shape (size), and the like to be controlled.

In the above embodiment, the content of both the peeking control and the overtaking control are changed according to the information related to the intersection area. However, only one control content of the peeking control and the overtaking control may be changed according to the information related to the intersection area IA. Furthermore, the respective change content of the peeking control and the overtaking control may be changed as appropriate.

In the overtaking control of the above embodiment, the lateral movement to return to the subject vehicle lane Lns after being out of the subject vehicle lane into the adjacent lane Lnd is performed. However, the travel control section 76 may suspend the control for returning to the subject vehicle lane Lns according to the situation of other surrounding vehicles. That is, the lane change to the adjacent lane Lnd may be performed in the overtaking control.

In the second modification of the above embodiment, a driving assistance ECU that performs the driving assistance control at Level 2 is provided separately from the automated driving ECU 50. As in the second modification, the automated driving system including the plurality of in-vehicle ECUs may correspond to an “automated driving control device”.

In the third modification of the above embodiment, each function of the automated driving ECU 50 and the HCU 100 is provided by one integrated ECU. In the third modification, the integrated ECU corresponds to an “automated driving control device”, and the HCU 100 corresponds to a “notification execution section”.

In the above embodiment, each function provided by the automated driving ECU and the HCU can be provided by software and hardware for executing the software, only software, only hardware, or a combination thereof. Furthermore, in a case where such a function is provided by an electronic circuit as hardware, each function can be provided by a digital circuit including a large number of logic circuits or an analog circuit. Furthermore, the software for realizing such a function may include, at least in part, a code automatically generated by a neural network or a language model trained using a camera image in the real world, for example.

Each processing section of the above-described embodiment has a configuration including at least one arithmetic core such as a central processing unit (CPU) and a graphics processing unit (GPU). The processing section may further include a field-programmable gate array (FPGA), a neural network processing unit (NPU), an IP core having another dedicated function, and the like. The processing section is not limited to the configuration individually mounted on the printed circuit board. The processing section may be implemented in an application specific integrated circuit (ASIC), a system on chip (SoC), a chiplet integrated body, an FPGA, or the like.

The form of the storage medium (continuous tangible computer reading medium, non-transitory tangible storage medium) that stores various programs and the like may be appropriately changed. Furthermore, the storage medium is not limited to the configuration provided on the circuit board, and may be provided in the form of a memory card or the like, inserted into the slot portion, and electrically connected to a control circuit such as an automated driving ECU or an HCU. Furthermore, the storage medium may be an optical disk, a hard disk drive, a solid state drive, or the like that is a copy source or a distribution source of a program to the automated driving ECU or the HCU.

The vehicle on which the automated driving ECU and the HMI system are mounted is not limited to a general private car, and may be a vehicle for a rental car, a vehicle for a manned taxi, a vehicle for ride-sharing, a cargo vehicle, a bus, or the like.

The control unit and its method described in the present disclosure may be implemented by a dedicated computer comprising a processor programmed to execute one or more functions embodied by a computer program. Alternatively, the apparatus and its method described in the present disclosure may be implemented by dedicated hardware logic circuits. Further, the apparatus and its method described in the present disclosure may be implemented by one or more dedicated computers configured by a combination of a processor that executes a computer program and one or more hardware logic circuits. In addition, the computer program may be stored as instructions executable by a computer on a non-transitory, computer-readable tangible recording medium.

What is claimed is:

1. An automated driving control device that enables traveling of a subject vehicle by an automated driving function, the automated driving control device comprising
at least one of (i) a circuit and (ii) a processor with a memory storing computer program code executable by the processor, the at least one of the circuit and the processor configured to cause the automated driving control device to implement:
an information grasping section configured to grasp an occurrence of an obstacle that obstructs traveling of the subject vehicle; and
a travel control section configured to sequentially perform peeking control of moving the subject vehicle so as to look in a situation ahead of the obstacle and overtaking control of overtaking the obstacle, in a case where the obstacle occurs in front of the subject vehicle,
wherein
in a case where the obstacle occurs in an intersection area located in front of the subject vehicle,
the travel control section changes content of at least one of the peeking control and the overtaking control according to information grasped by the information grasping section in relation to the intersection area.

2. The automated driving control device according to claim 1, wherein
the travel control section changes the content of the peeking control between in a case where the peeking control is performed in the intersection area and in a case where the peeking control is performed outside the intersection area.

3. The automated driving control device according to claim 1, wherein
the travel control section changes a distance from the subject vehicle to the obstacle in the peeking control between in a case where the peeking control is performed in the intersection area and in a case where the peeking control is performed outside the intersection area.

4. The automated driving control device according to claim 1, wherein
the travel control section makes a distance from the subject vehicle to the obstacle longer in a case where the peeking control is performed in the intersection area than in a case where the peeking control is performed outside the intersection area.

5. The automated driving control device according to claim 1, wherein
the travel control section
performs a temporary stop of the subject vehicle in a case where the peeking control is performed outside the intersection area, and
omits the temporary stop in a case where the peeking control is performed in the intersection area.

6. The automated driving control device according to claim 1, wherein
the information grasping section grasps a following vehicle traveling behind the subject vehicle, and
the travel control section changes the content of the peeking control according to presence or absence of the following vehicle grasped by the information grasping section.

7. The automated driving control device according to claim 1, wherein
the information grasping section grasps whether a traffic signal is installed in the intersection area, and
the travel control section
performs the peeking control in a case where the traffic signal is installed in the intersection area, and
restricts execution of the peeking control in a case where the traffic signal is not installed in the intersection area.

8. The automated driving control device according to claim 1, wherein
the information grasping section grasps a state of a traffic signal installed in the intersection area, and
the travel control section restricts execution of the peeking control in a case where the traffic signal is in lighting state in yellow.

9. The automated driving control device according to claim 1, wherein
the information grasping section grasps a preceding vehicle located in front of the subject vehicle in the intersection area, and
the travel control section restricts execution of the peeking control in which the preceding vehicle is set as the obstacle in a case where the preceding vehicle is moving.

10. The automated driving control device according to claim 1, wherein
the travel control section performs the peeking control in a direction opposite an overtaking side direction in which the overtaking control is performed in a left-right direction of the subject vehicle.

11. The automated driving control device according to claim 1, wherein
the travel control section changes the content of the overtaking control between in a case where the overtaking control is performed in a section including the intersection area and in a case where the overtaking control is performed in a section not including the intersection area.

12. The automated driving control device according to claim 1, wherein
the travel control section suppresses a traveling speed of the subject vehicle in the overtaking control in a case where the overtaking control is performed in a section including the intersection area, compared with in a case where the overtaking control is performed in a section not including the intersection area.

13. The automated driving control device according to claim 1, wherein
the information grasping section determines whether there is a space for the subject vehicle, the space being ahead of the intersection area, before the subject vehicle enters the intersection area, and
the travel control section suppresses a traveling speed of the subject vehicle in the overtaking control in a case where there is not the space, compared with in a case where there is the space.

14. The automated driving control device according to claim 1, wherein
the information grasping section determines whether a space for the subject vehicle, the space being ahead of the intersection area, before the subject vehicle enters the intersection area, and
the travel control section restricts entry of the subject vehicle into the intersection area in the overtaking control in a case where there is not the space.

15. The automated driving control device according to claim 1, wherein
the travel control section increases a degree of curved movement of the subject vehicle in a direction away from the obstacle to be overtaken in a case where the overtaking control is performed in a section including the intersection area, compared with in a case where the overtaking control is performed in a section not including the intersection area.

16. The automated driving control device according to claim 1, wherein
the information grasping section grasps whether a pedestrian is present in a waiting area facing the intersection area, and
the travel control section increases a degree of curved movement of the subject vehicle in a direction away from the pedestrian by the overtaking control in a case where the pedestrian is present in the waiting area, compared with is a case where the pedestrian is not present in the waiting area.

17. The automated driving control device according to claim 1, wherein
in a case where the information grasping section grasps a preceding vehicle located in the intersection area as the obstacle,
the information grasping section further grasps an irregular behavior of the preceding vehicle, and
the travel control section
temporarily stops the subject vehicle in a case where the irregular behavior is grasped after the overtaking control is started, and
causes the subject vehicle to follow the preceding vehicle in a case where the irregular behavior is grasped before the overtaking control is started.

18. The automated driving control device according to claim 1, wherein
the information grasping section grasps an oncoming vehicle traveling in an opposite lane in the intersection area, and
the at least one of the circuit and the processor is further configured to cause the automated driving control device to implement
a device control section configured to operate a direction indicator of the subject vehicle in accordance with the overtaking control in a case where the oncoming vehicle is present in the opposite lane, and to omit an operation of the direction indicator accompanying the overtaking control in a case where the oncoming vehicle is not present in the opposite lane.

19. A non-transitory computer readable storage medium storing an automated driving control program that enables traveling of a subject vehicle by an automated driving function, the automated driving control program for causing at least one processing section to executes:
grasping an occurrence of an obstacle that obstructs traveling of the subject vehicle;
sequentially performing peeking control of moving the subject vehicle so as to look in a situation ahead of the obstacle and overtaking control of overtaking the obstacle in a case where the obstacle occurs in front of the subject vehicle; and
changing, in a case where the obstacle occurs in an intersection area located in front of the subject vehicle, content of at least one of the peeking control and the overtaking control according to information grasped in relation to the intersection area.

20. An automated driving control method that enables traveling of a subject vehicle by an automated driving function, the automated driving control method executed by at least one processing section, the automated driving control method comprising:
grasping an occurrence of an obstacle that obstructs traveling of the subject vehicle;
sequentially performing peeking control of moving the subject vehicle so as to look in a situation ahead of the obstacle and overtaking control of overtaking the obstacle in a case where the obstacle occurs in front of the subject vehicle; and
changing, in a case where the obstacle occurs in an intersection area located in front of the subject vehicle, content of at least one of the peeking control and the overtaking control according to information grasped in relation to the intersection area.
